(19) United States
(12) Patent Application Publication
(10) Pub. No.: US 2017/0308893 A1
(43) Pub. Date: Oct. 26, 2017

(54) ASSET AND OBLIGATION MANAGEMENT USING FLEXIBLE SETTLEMENT TIMES

(71) Applicant: Digital Asset Holdings, New York, NY (US)

(72) Inventor: Walter Eric Saraniecki, New York, NY (US)

(21) Appl. No.: 15/247,546

(22) Filed: Aug. 25, 2016

Related U.S. Application Data
(60) Provisional application No. 62/327,360, filed on Apr. 25, 2016.

(51) Int. Cl. G06Q 20/38; G06Q 40/02; H04L 29/06

(52) U.S. Cl. CPC G06Q 20/3821; H04L 63/08; G06Q 40/02; G06Q 2220/00

(57) ABSTRACT

A system and method are provided for managing a transaction having at least one enduring obligation and at least one repo obligation with respect to a plurality of assets, where the system includes at least one signing server for authorizing the at least one enduring obligation and the at least one repo obligation.

### CROSS-REFERENCE

This application claims priority under 35 USC §119 to U.S. Provisional Patent Application No. 62/327,360 entitled ASSET AND OBLIGATION MANAGEMENT USING FLEXIBLE SETTLEMENT TIMES, filed on Apr. 25, 2016 in the United States Patent and Trademark Office (USPTO), the contents of which are herein incorporated by reference in their entirety.

### TECHNICAL FIELD

The present disclosure relates to asset and obligation management using flexible settlement times for digital assets and obligations as well as for digitally-managed traditional assets and obligations.

### BACKGROUND

Legacy financial infrastructure, traditionally based on centralized hub-and-spoke database architectures, are expensive, inefficient and vulnerable to operational failure and cyberattack. Multiple entities keep records of the similar but incomplete information and attempt to ensure its consistency through a cumbersome reconciliation process. Settlement latency and failures arise because transaction information is recorded separately and errors are not identified and rectified until late in the post-trade process. Regulatory focus on enhanced transparency, reduced counterparty risk and expedited settlement times are also placing challenging demands on existing infrastructure. These problems occur across many areas of post-trade processing and record-keeping, which results in high costs, capital requirements and added counterparty, operational, and cyber-security risks.

Bilateral, OTC, electronic, and centrally cleared transaction volumes are placing existing infrastructure under tremendous strain. Each one of these matched transactions represents the creation of obligations for the buyer, seller, and all intermediaries to fulfill their responsibilities in order to settle the transaction. These intermediary roles exist in order to facilitate large pools of liquidity for price discovery and guarantee the performance of the actors in price discovery.

In spite of increasingly improved venues and platforms created to increase the efficiency of creating a matched transaction, corresponding match recordation and obligation creation still differs widely across the parties to the transaction. To begin with, the buyer and seller in a transaction may each only see and record their own side of the transaction and bilateral obligations, creating a partial record of the event. If the transaction was centrally cleared, a central counterparty clearinghouse (CCP) would see and record both sides of the transaction and two pairs of bilateral obligations. In this simplistic example, there would be three independent, and for two out of the three parties, partially complete, records of the transaction. Each party to the transaction may consume, reformat, and persist this information however it likes and in its own recordation systems. This means that each participant may accidentally drop a message, reformat improperly, or edit its records incorrectly without the other parties being privy to such alterations. It is common practice for integrated post-trade systems to strip enriched data, only to be re-enriched later in the process, due to use of multiple different data formats.

This is the driving force behind reconciliation of records across market participants. Each participant receives partial information, can store and edit that information as it likes, and will report information to its counterparties typically in aggregate form. As a result, all parties to each transaction independently maintain all the information that they have and compare with their respective counterparties. Reconciliation is difficult because no single party can be certain the information it holds is correct nor that its counterparties hold correct information. Thus, reconciliation is not simply the process of comparing what is wrong to what is right. Instead it is the process of looking at multiple records, each of which could be wrong, and undergoing a costly and cumbersome process to agree on the truth. As a result of this, financial institutions are spending a significant amount of their operational outlays on the generation, communication and reconciliation of vast quantities of unique data.

This information that is being maintained and reconciled across all market participants represents the obligations for each party to deliver and settle at some point in the future. Each market and asset has its own definition for what is the proper time period for which settlement of obligations is required and each market has its own rules for how one is required to satisfy its obligations.

### SUMMARY

An exemplary embodiment method is provided for managing a transaction having at least one enduring obligation and at least one repo obligation with respect to a plurality of assets, the method comprising authorizing the at least one enduring obligation and the at least one repo obligation through a mutual append-only transactional log.

The method may optionally be used where the at least one enduring obligation and the at least one repo obligation form an obligation bundle. The method may optionally include communicating statuses of the obligations among a plurality of participants. The method may optionally be used where the plurality of participants includes a central counterparty clearinghouse associated with a first signing server.

The method may optionally be used where the plurality of assets comprises two assets selected from the group consisting of cash, securities and equities. The method may optionally be used where the plurality of assets includes at least one of a digital asset or a tokenized non-digital asset. The method may optionally be used where the mutual append-only transactional log is a blockchain ledger.

The method may optionally include matching at least one enduring obligation of a first party with at least one repo obligation of a second party by receiving a Business Intent Message (BIM) based on the respective obligations of the parties; selecting a transaction processing algorithm based on the BIM; selecting relationship nodes for transaction processing based on the BIM; and providing a Business Intent Transaction (BIT) based on the selected algorithm and nodes.

An exemplary embodiment asset management system includes at least one signing server configured to manage a transaction having at least one enduring obligation and at least one repo obligation with respect to a plurality of assets, wherein the at least one signing server is configured to authenticate said obligations through an append-only log.

The system may optionally be used where the at least one enduring obligation and the at least one repo obligation form an obligation bundle. The system may optionally be used where the at least one signing server is disposed for communicating statuses of the obligations among a plurality of participants. The system may optionally be used where transfers of the plurality of assets are controlled by a plurality of participants, including a central counterparty clearinghouse associated with a first signing server.

The system may optionally be used where the plurality of assets comprises two assets selected from the group consisting of cash, securities and equities. The system may optionally be used where the plurality of assets includes at least one of a digital asset or a tokenized non-digital asset. The system may optionally be used where the mutual append-only transactional log is a blockchain ledger.

The system may optionally include business means for matching the at least one enduring obligation of a first party with the at least one repo obligation of a second party by receiving a Business Intent Message (BIM) based on the respective obligations of the parties; core means for selecting a transaction processing algorithm based on the BIM; first strategy means for selecting relationship nodes for transaction processing based on the BIM; and second strategy means for providing a Business Intent Transaction (BIT) based on the selected algorithm and nodes.

An exemplary embodiment program storage device is provided tangibly embodying a program of instructions executable by a computer to perform steps for managing a transaction having at least one enduring obligation and at least one repo obligation with respect to a plurality of assets, the steps comprising authorizing the at least one enduring obligation and the at least one repo obligation through a mutual append-only transactional log.

The steps may optionally be used where the at least one enduring obligation and the at least one repo obligation form an obligation bundle. The steps may optionally include communicating statuses of the obligations among a plurality of participants. The steps may optionally be used where the plurality of participants includes a central counterparty clearinghouse associated with a first signing server.

The steps may optionally be used where the plurality of assets comprises two assets selected from the group consisting of cash, securities and equities. The steps may optionally be used where the plurality of assets includes at least one of a digital asset or a tokenized non-digital asset. The steps may optionally be used where the mutual append-only transactional log is a blockchain ledger.

The steps may optionally include matching at least one enduring obligation of a first party with at least one repo obligation of a second party by receiving a Business Intent Message (BIM) based on the respective obligations of the parties; selecting a transaction processing algorithm based on the BIM; selecting relationship nodes for transaction processing based on the BIM; and providing a Business Intent Transaction (BIT) based on the selected algorithm and nodes.

### BRIEF DESCRIPTION OF THE DRAWINGS

Illustrative, non-limiting exemplary embodiments may be more clearly understood from the following detailed description, particularly when taken in conjunction with the accompanying drawings, in which:

FIG. 1 is a block diagram showing a digital asset management system having a market administrator participant (e.g., central counterparty clearinghouse) for registration of account IDs in a business logic engine (BLE) in accordance with an exemplary embodiment of the present disclosure;

FIG. 2 is a block diagram showing authorizers and the accounts they service in accordance with an exemplary embodiment of the present disclosure;

FIG. 3 is a block diagram showing other authorizers and the customers they service in accordance with an exemplary embodiment of the present disclosure;

FIG. 4 is a flowchart showing order matching and transaction processing in accordance with an exemplary embodiment of the present disclosure;

FIG. 5 is a hybrid diagram showing a bilateral match action in accordance with an exemplary embodiment of the present disclosure;

FIG. 6 is a hybrid diagram showing an issuance action in accordance with an exemplary embodiment of the present disclosure;

FIG. 7 is a state diagram showing a first variant of a clearing and settlement workflow in accordance with an exemplary embodiment of the present disclosure;

FIG. 8 is a state diagram showing a second variant of a clearing and settlement workflow in accordance with an exemplary embodiment of the present disclosure;

FIG. 9 is a state diagram showing a third variant of a clearing and settlement workflow in accordance with an exemplary embodiment of the present disclosure;

FIG. 10 is a state diagram showing a fourth variant of a clearing and settlement workflow in accordance with an exemplary embodiment of the present disclosure;

FIG. 11 is a tabular diagram showing a decision process for selecting among the first through fourth variants of FIGS. 7 through 10 in accordance with an exemplary embodiment of the present disclosure;

FIG. 12 is a hybrid diagram showing a centrally cleared match action in accordance with an exemplary embodiment of the present disclosure;

FIG. 13 is a hybrid diagram showing an allocation action in accordance with an exemplary embodiment of the present disclosure;

FIG. 14 is a hybrid diagram showing a multi-action allocation in accordance with an exemplary embodiment of the present disclosure;

FIG. 15 is a hybrid diagram showing a ready for settle action in accordance with an exemplary embodiment of the present disclosure;

FIG. 16 is a hybrid diagram showing another ready for settle action in accordance with an exemplary embodiment of the present disclosure;

FIG. 17 is a hybrid diagram showing a commit action in accordance with an exemplary embodiment of the present disclosure;

FIG. 18 is a hybrid diagram showing a settle action in accordance with an exemplary embodiment of the present disclosure;

FIG. 19 is a hybrid diagram showing a repo with immediate settlement action in accordance with an exemplary embodiment of the present disclosure;

FIG. 20 is a hybrid diagram showing a repo with as soon as possible settlement action in accordance with an exemplary embodiment of the present disclosure;

FIG. 21 is a hybrid diagram showing a repo with end-of-day (EOD) settlement action in accordance with an exemplary embodiment of the present disclosure;

FIG. 22 is a hybrid diagram showing a repo action with immediate settlement and central counterparty clearinghouse (CCP) clearance in accordance with an exemplary embodiment of the present disclosure;

FIG. 23 is a hybrid diagram showing a repo action with as-soon-as-possible (ASAP) settlement and CCP clearance in accordance with an exemplary embodiment of the present disclosure;

FIG. 24 is a hybrid diagram showing a repo action with end-of-day (EOD) settlement and CCP clearance in accordance with an exemplary embodiment of the present disclosure;

FIG. 25 is a hybrid diagram showing an obligations reduction action in accordance with an exemplary embodiment of the present disclosure;

FIG. 26 is a hybrid diagram showing an obligations reduction with preference fee action in accordance with an exemplary embodiment of the present disclosure;

FIG. 27 is a hybrid diagram showing a settlement liquidity action in accordance with an exemplary embodiment of the present disclosure;

FIG. 28 is a hybrid diagram showing a settlement liquidity action in accordance with an exemplary embodiment of the present disclosure;

FIG. 29 is a hybrid diagram showing a settlement liquidity action with preference fee in accordance with an exemplary embodiment of the present disclosure;

FIG. 30 is a hybrid diagram showing a basic net action with bilateral, same name and same date attributes in accordance with an exemplary embodiment of the present disclosure;

FIG. 31 is a hybrid diagram showing an intermediate net action with bilateral, same name and same date attributes, and ‘Ready for Settle’ flag set in accordance with an exemplary embodiment of the present disclosure;

FIG. 32 is a hybrid diagram showing an advanced net action with bilateral and same name, but across dates attributes in accordance with an exemplary embodiment of the present disclosure;

FIG. 33 is a hybrid diagram showing Step 1 of a batched settlement for Locked Inventory Optimization in accordance with an exemplary embodiment of the present disclosure;

FIG. 34 is a hybrid diagram showing Step 2 of a batched settlement for Locked Inventory Optimization in accordance with an exemplary embodiment of the present disclosure;

FIG. 35 is a hybrid diagram showing Step 3 of a batched settlement for Locked Inventory Optimization in accordance with an exemplary embodiment of the present disclosure;

FIG. 36 is a hybrid diagram showing Step 4 of a batched settlement for Locked Inventory Optimization in accordance with an exemplary embodiment of the present disclosure;

FIG. 37 is a hybrid diagram showing Step 5 of a batched settlement for Locked Inventory Optimization in accordance with an exemplary embodiment of the present disclosure;

FIG. 38 is a hybrid diagram showing Step 6 of a batched settlement for Locked Inventory Optimization in accordance with an exemplary embodiment of the present disclosure;

FIG. 39 is a hybrid diagram showing Step 7 of a batched settlement for Locked Inventory Optimization in accordance with an exemplary embodiment of the present disclosure;

FIG. 40 is a hybrid diagram showing Step 8 of a batched settlement for Locked Inventory Optimization in accordance with an exemplary embodiment of the present disclosure;

FIG. 41 is a hybrid diagram showing Step 9 of a batched settlement for Locked Inventory Optimization in accordance with an exemplary embodiment of the present disclosure;

FIG. 42 is a hybrid diagram showing Step 1 of a batched settlement for a generic commit in accordance with an exemplary embodiment of the present disclosure;

FIG. 43 is a hybrid diagram showing Step 2 of a batched settlement for a generic commit in accordance with an exemplary embodiment of the present disclosure;

FIG. 44 is a hybrid diagram showing Step 3 of a batched settlement for generic commit in accordance with an exemplary embodiment of the present disclosure;

FIG. 45 is a hybrid diagram showing Step 4 of a batched settlement for generic commit in accordance with an exemplary embodiment of the present disclosure;

FIG. 46 is a hybrid diagram showing Step 5 of a batched settlement for generic commit in accordance with an exemplary embodiment of the present disclosure;

FIG. 47 is a hybrid diagram showing Step 6 of a batched settlement for generic commit in accordance with an exemplary embodiment of the present disclosure;

FIG. 48 is a hybrid diagram showing Step 7 of a batched settlement for generic commit in accordance with an exemplary embodiment of the present disclosure;

FIG. 49 is a hybrid diagram showing Step 8 of a batched settlement for generic commit in accordance with an exemplary embodiment of the present disclosure;

FIG. 50 is a hybrid diagram showing Step 9 of a batched settlement for generic commit in accordance with an exemplary embodiment of the present disclosure;

FIG. 51 is a hybrid diagram showing Step 1 of a cross-day netting transaction in accordance with an exemplary embodiment of the present disclosure;

FIG. 52 is a hybrid diagram showing Step 2 of a cross-day netting transaction in accordance with an exemplary embodiment of the present disclosure;

FIG. 53 is a hybrid diagram showing Step 3 of a cross-day netting transaction in accordance with an exemplary embodiment of the present disclosure;

FIG. 54 is a hybrid diagram showing Step 4 of a cross-day netting transaction in accordance with an exemplary embodiment of the present disclosure; and

FIGS. 55-57 are hybrid diagrams showing a unified ledger of enduring and repo obligations.

### DETAILED DESCRIPTION

The present inventive concept is directed towards obligation management and settlement, for both digital and traditional assets, with flexible settlement times, including both enduring asset and repurchase agreement (repo) obligations in the same market transaction. The present inventive concept will be described more fully with reference to the accompanying drawings, in which exemplary embodiments are shown. The present inventive concept may, however, be embodied in many different forms and should not be construed as being limited to the embodiments set forth herein. Like reference numerals may refer to like elements throughout this disclosure.

An exemplary embodiment digital asset platform in accordance with the present inventive concept allows for the creation of a mutualized transaction record, or ledger, which contains an encrypted copy of all ledger entries for all participants in the network. All parties to each ledger entry must cryptographically approve the entry in order for it to become valid and accepted into the ledger. As a result, the ledger is an append-only log of multi-party, multi-signature transactions that cannot be unilaterally altered or edited by any single participant or without each participant being aware of the alteration. The combination of highly structured data and a multi-party confirmation process creates an authoritative prime record, thus eliminating cross-party reconciliation and providing the real-time state of each transaction. As settlement certainty and speed increase, net risk and collateral requirements in the financial system generally decrease.

When a complete record of all obligations for an instrument or market are maintained on such a unified platform and can be assured to be correct, there are tremendous opportunities to reduce risk for intermediaries in the market and create flexible settlement schema. The shift towards mutualized infrastructure and services is already well underway, while the mutualization of authoritative data is just getting started. The main barriers to a fully shared database are maintaining the integrity, security, and privacy of the contents that each participant enjoys today from traditional silos of information. An exemplary embodiment obligation management and settlement system accepts fully dematerialized assets, including equities, securities and cash, can represent traditional assets external to the system, acquires price discovery external to the system, including initial match and repo match, allows for other price discovery internal to the system, including a ready to settle preference fee, and replicates roles and responsibilities for trading participants (TP) such as dealers, clearing (CP) such as members, central counterparty clearinghouses (CCP) such as market administrator participants, and settlement participants (SP) such as custodians; and redefines settlement workflows and opportunities. Bilateral transactions without a CCP or market administrator are also representable.

As used herein, an obligor is an entity that has issued an obligation to deliver an asset of defined type, and an account is used for holding a fungible asset of defined type. A token is a digital record or representation signifying ownership of an asset. The asset may be a native digital asset, a traditional asset, or any right or duty, such as, but not limited to, a contractual duty. An authorizer or controller represents the entity that is required to approve and sign the presented action. A transition or transfer represents the transfer of control from an entity that has issued an obligation to deliver an asset of defined type. A primary asset reference is the reference for the primary obligation or fungible asset defined in a transfer. A secondary asset reference is the reference for the secondary obligation or fungible asset defined in a transfer. Obligation destruction denotes the destruction of an obligation or atomic bundle of obligations in conjunction with the creation of a new obligation or bundle or a final settlement.

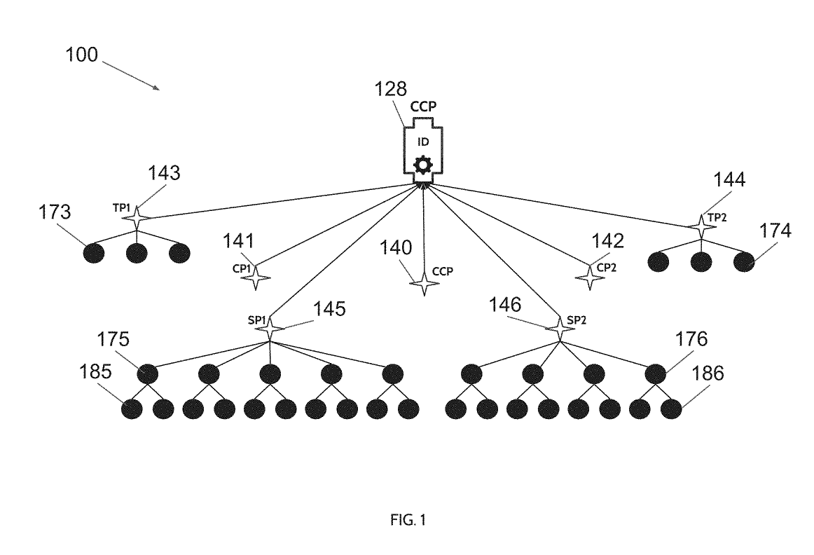

As shown in FIG. 1, an exemplary embodiment digital asset management system 100 is configured for signing servers to register account identifications with a business logic engine (BLE) implemented by a central counterparty clearinghouse (CCP) or market administrator participant. Here, the CCP 140 validates the registrations of signing servers CP1 141, CP2 142, TP1 143, TP2 144, SP1 145, and SP2 146. Dealer or trading participant TP1 is connected to customers 173; dealer or trading participant TP2 is connected to customers 174; custodian or settlement participant SP1 is connected to customers 175, which, in turn, are connected to sub-customers 185; and custodian or settlement participant SP2 is connected to customers 176, which, in turn, are connected to sub-customers 186.

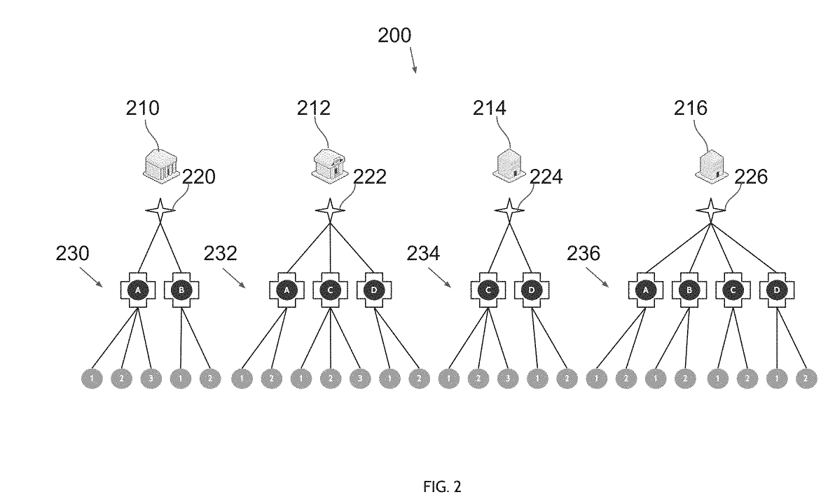

Turning to FIG. 2, an exemplary embodiment authorizer and account hierarchy 200 includes authorizers such as an agent 210, a custodian 212, a fund 214, and a vendor 216. The authorizers, which may include agents, custodians, dealers, large participants, and vendors, provide authorization. Here, the agent uses an agent's signing server 220, the custodian uses a custodian's signing server 222, the fund uses a fund's signing server 224, and the vendor uses a vendor's signing server 226.

The signing servers service designated cryptographic accounts that have delegated a respective authorizer. The accounts, in turn, provide access to a further list of designated sub-accounts for the logical separation of inventory under an account (e.g., ‘Open’ versus ‘Commit’).

The agent's signing server services designated cryptographic accounts 230A and 230B. Account 230A provides access for sub-accounts 230A1, 230A2 and 230A3; while account 230B provides access for sub-accounts 230B1 and 230B2.

The custodian's signing server services designated cryptographic accounts 232A, 232C and 232D. Account 232A provides access for sub-accounts 232A1 and 232A2; while account 232C provides access for sub-accounts 232C1, 232C2 and 232C3; and account 232D provides access for sub-accounts 232D1 and 232D2.

The fund's signing server services designated cryptographic accounts 234C and 234D. Account 234C provides access for sub-accounts 234C1, 234C2 and 234C3; while account 234D provides access for sub-accounts 234D1 and 234D2.

The vendor's signing server services designated cryptographic accounts 236A. 236B, 236C and 236D. Account 236A provides access for sub-accounts 236A1 and 236A2. Account 236B provides access for sub-accounts 236B1 and 236B2. Account 236C provides access for sub-accounts 236C1 and 236C2. Account 236D provides access for sub-accounts 236D1 and 236D2.

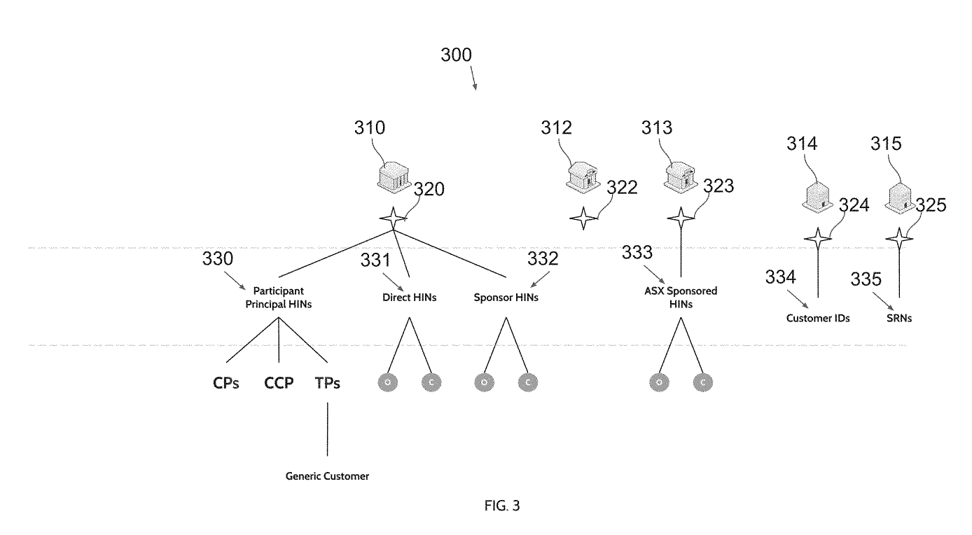

Turning now to FIG. 3, an exemplary embodiment authorizer and account hierarchical system adapted for the Australian Stock Exchange (ASX) is indicated generally by the reference numeral 300. The system comprises authorizers including a settlement participant (SP) 310, a clearing participant (CP) 312, a central counterparty clearinghouse (CCP) 313, a trading participant (TP) 314, and a Registry 315. The authorizers are market participants that provide authorization. Signing servers are used by the market participants to authorize actions in the market. Here, the SP uses a first signing server 320, the CP uses a second signing server 322, the CCP uses a third signing server 323, the TP uses a fourth signing server 324, and the Issuer Registry uses a fifth signing server 325.

The signing servers service designated cryptographic accounts, which have delegated a respective authorizer. The accounts, in turn, provide access to a further list of designated sub-accounts for the logical separation of inventory under an account (e.g., ‘Open’ versus ‘Commit’).

The signing servers service designated accounts (e.g., cryptographic accounts) that have designated the authorizers. The SP's signing server 320 services designated cryptographic accounts for participant principal Holder Identification Numbers (HINs) 330, direct HINs 331, and sponsor HINs 332. HINs are used by the Clearing House Electronic Sub-register System (CHESS), which is the system used by the ASX to record share holdings. The CCP's signing server 323 services ASX Sponsored HINs 333. The TP's signing server 324 services Customer IDs 334. The Issuer Registry's signing server 325 services Security Reference Numbers (SRNs) 335 for issuer-sponsored shares.

The designated cryptographic accounts may have designated sub-accounts for the logical separation of inventory under an account (e.g., ‘Open’ or ‘Commit’). For example, Participant Principal HIN accounts may have sub-accounts including CP sub-accounts, CCP sub-accounts, and TP sub-accounts, where the TP sub-accounts may have further Generic Customer sub-sub-accounts. The various HIN accounts may each have Open (“0”) and Commit (“C”) sub-accounts.

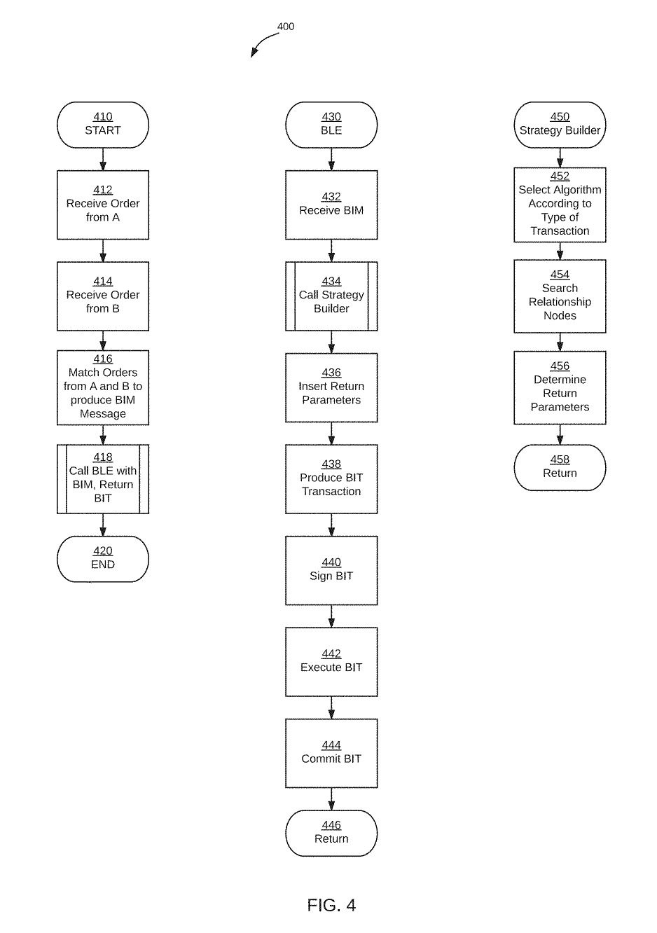

As shown in FIG. 4, a business method for order matching and transaction processing is indicated generally by the reference numeral 400. Here, a start block 410 passes control to a processing block 412, which receives an order from Party A and passes control to a processing block 414. The block 414 receives an order from Party B, and passes control to a processing block 416. The block 416 matches the order of Party A with the order of Party B to produce a Business Intent Message (BIM), and passes control to a Business Logic Engine (BLE) function call block 418. The block 418 calls the BLE function passing the BIM as an input, and returns a Business Intent Transaction (BIT). The block 418 passes control to an end block 420. It shall be understood that blocks 410 through 414 are provided for context, and that the presently described exemplary embodiment of the inventive concept is addressed by blocks 430 through 458.

A BLE function start block 430 passes control to a processing block 432, which receives the BIM and passes control to a Strategy Builder function call block 434, which, in turn, passes control to a processing block 436. The block 436 inserts return parameters from the Strategy Builder into a data structure, and passes control to a processing block 438. The block 438 produces a BIT transaction, and passes control to a processing block 440. The block 440 coordinates signing of the BIT and passes control to a processing block 442. The block 442, in turn, coordinates execution of the BIT and passes control to a processing block 444. The block 444 commits the BIT to a mutual append-only transactional log or distributed ledger, and passes control to a return block 446. While this exemplary embodiment uses the described order of sign 440, execute 442 and commit 444 all on-ledger, an alternate embodiment may use an off-ledger message queue and the different order of execute 442 and then sign 440, both off-ledger, with only the final commit 444 being written to the ledger.

A Strategy Builder function start block 450 passes control to a processing block 452. The block 452 selects an algorithm from a set of pre-defined algorithms based on the type of transaction represented by the BIM, and passes control to a processing block 454. The block 454 searches the relationship nodes for available actors, and passes control to a processing block 456. The block 456, in turn, determines the return parameters and passes control to a return block 458.

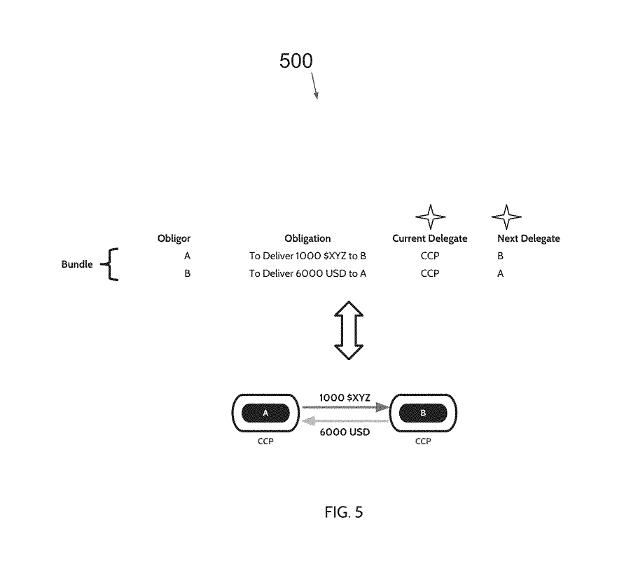

Turning to FIG. 5, a bilateral match action is indicated generally by the reference numeral 500. Here, a bundle includes a first obligation of customer A as obligor using a central counterparty clearinghouse CCP as authorizer to transfer quantity 1000 of primary asset $XYZ to the account of Customer B. The bundle includes a second obligation of customer B as obligor using the CCP as authorizer to transfer quantity 6000 of secondary asset USD to the account of Customer A.

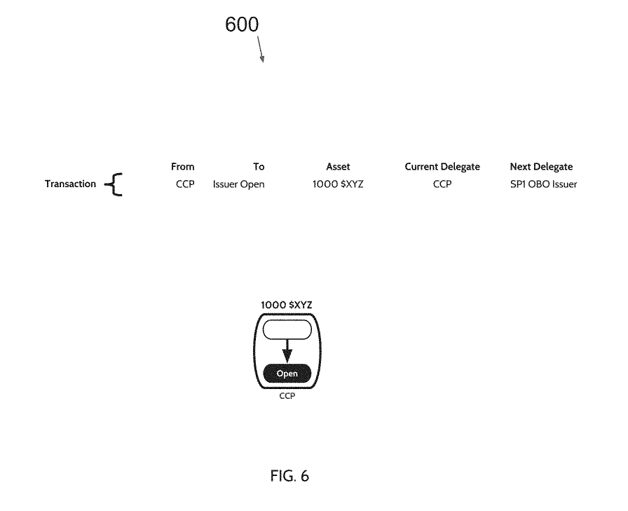

Turning now to FIG. 6, an issuance action is indicated generally by the reference numeral 600. Here, a transaction includes a single authorization of an administrative party (e.g., a central counterparty clearinghouse CCP) to create quantity 1000 of asset $XYZ to an Issuer's account, where the next authorizer is settlement participant SP1 on behalf of (OBO) Issuer.

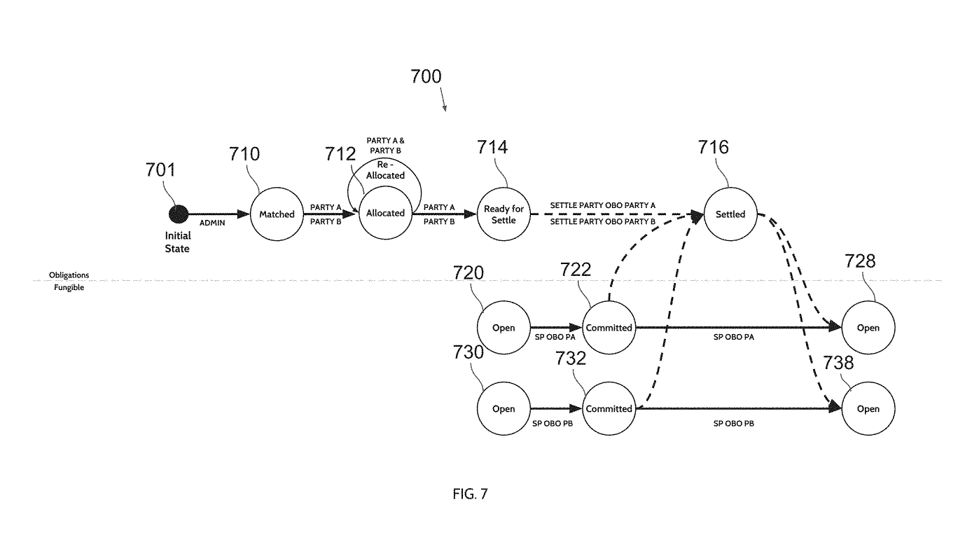

As shown in FIG. 7, a state diagram for Clearing and Settlement (C&S) Workflow, Variant 1 (V1), is indicated generally by the reference numeral 700. Here, reference numerals 701-716 (above the dashed line) refer to the states of obligations, while reference numerals 720-738 (below the dashed line) refer to the states of fungible assets.

An Initial State 701, with respect to a transaction comprising at least one bundle of obligations, is transitioned by ADMIN to a Matched state 710. The obligations of PARTY A and PARTY B are transitioned by the respective obligors from the Matched state to an Allocated state 712, and may be re-allocated as needed by the respective obligors. For example, re-allocation may be for correction, or for breaking an order down further where the trade is generically tagged at match, assigned to a new party, and then re-assigned a number of times in parts. The obligations of PARTY A and PARTY B are then transitioned by the respective obligors from the Allocated state to a Ready for Settle state 714.

PARTY A's fungible asset is placed in an Open account state 720, and transitioned to a Committed account state 722 by a Settlement Party (SP) on behalf of (OBO) PARTY A (PA). PARTY B's fungible asset is placed in an Open account state 730, and transitioned to a Committed account state 732 by a Settlement Party on behalf of (OBO) PARTY B (PB). Once all necessary fungible assets are in Committed account states, the obligations state may be transitioned from the Ready to Settle state to a Settled state 716 by a Settlement Party on behalf of PARTY A and a Settlement Party on behalf of PARTY B, each for their respective fungible assets. Each action obligation remains under the control of the direct participants until passed to custodians with the ‘ready for settle’ action. Once settled, Party A's original asset is moved to an Open account state 728, and Party B's original asset is moved to an Open account state 738. Here, the SP is not allowed to touch accounts in an Open state, but the SP is allowed to use the inventory from accounts in a Commit state. In alternate embodiments, the concepts of different accounts or account states may extend to many more separations, such as, for example, ‘encumbered’ meaning it is being used in another system, or ‘stepped on’ meaning it is reserved for something in particular.

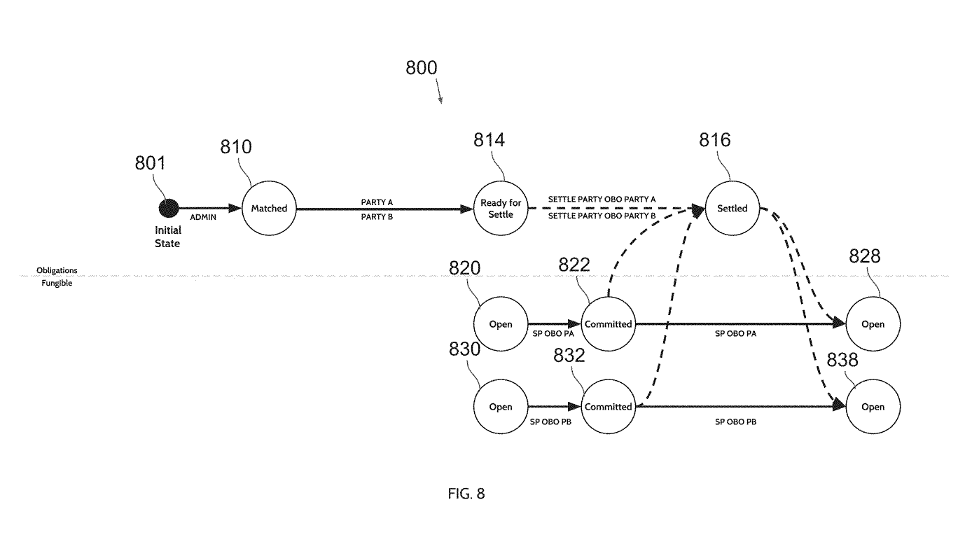

Turning to FIG. 8, a state diagram for Clearing and Settlement (C&S) Workflow, Variant 2 (V2), is indicated generally by the reference numeral 800. Here, reference numerals 801-816 (above the dashed line) refer to the states of obligations, while reference numerals 820-838 (below the dashed line) refer to the states of fungible assets.

An Initial State 801, with respect to a transaction comprising at least one bundle of obligations, is transitioned by ADMIN to a Matched state 810. The obligations of PARTY A and PARTY B are transitioned by the respective obligors from the Matched state to a Ready for Settle state 814.

PARTY A's fungible asset is placed in an Open account state 820, and transitioned to a Committed account state 822 by a Settlement Party on behalf of (OBO) PARTY A (PA). PARTY B's fungible asset is placed in an Open account state 830, and transitioned to a Committed account state 832 by a Settlement Party on behalf of (OBO) PARTY B (PB). Once all necessary fungible assets are in Committed account states, the obligations state may be transitioned from the Ready to Settle state to a Settled state 816 by a Settlement Party on behalf of PARTY A and a Settlement Party on behalf of PARTY B, each for their respective fungible assets. Once settled, Party A's original asset is moved to an Open account state 828, and Party B's original asset is moved to an Open account state 838.

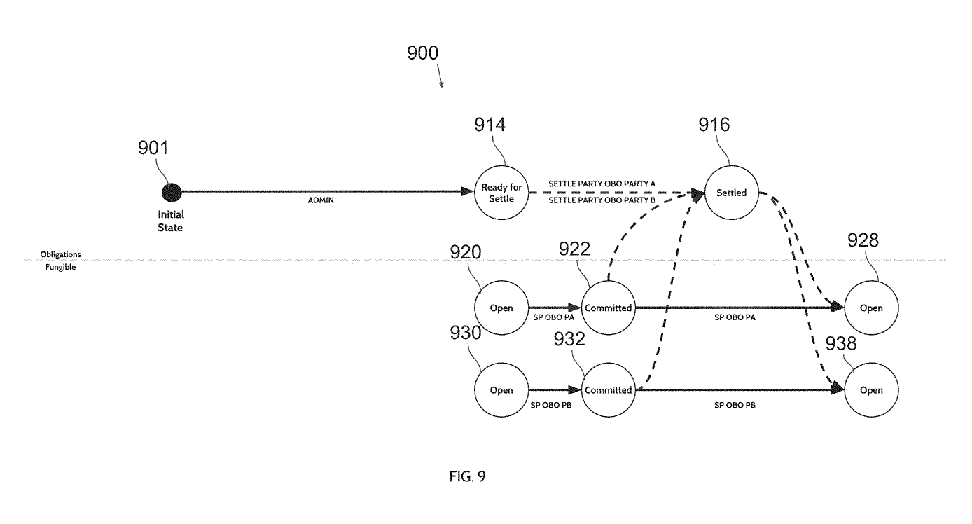

Turning now to FIG. 9, a state diagram for Clearing and Settlement (C&S) Workflow, Variant 3 (V3), is indicated generally by the reference numeral 900. Here, reference numerals 901-916 (above the dashed line) refer to the states of obligations, while reference numerals 920-938 (below the dashed line) refer to the states of fungible assets.

An Initial State 901, with respect to a transaction comprising at least one bundle of obligations, is transitioned by ADMIN to a Ready for Settle state 914. PARTY A's fungible asset is placed in an Open account state 920, and transitioned to a Committed account state 922 by a Settlement Party on behalf of (OBO) PARTY A (PA). PARTY B's fungible asset is placed in an Open account state 930, and transitioned to a Committed account state 932 by a Settlement Party on behalf of (OBO) PARTY B (PB). Once all necessary fungible assets are in Committed account states, the obligations state may be transitioned from the Ready to Settle state to a Settled state 916 by a Settlement Party on behalf of PARTY A and a Settlement Party on behalf of PARTY B, each for their respective fungible assets. Once settled, Party A's original asset is moved to an Open account state 928, and Party B's original asset is moved to an Open account state 938.

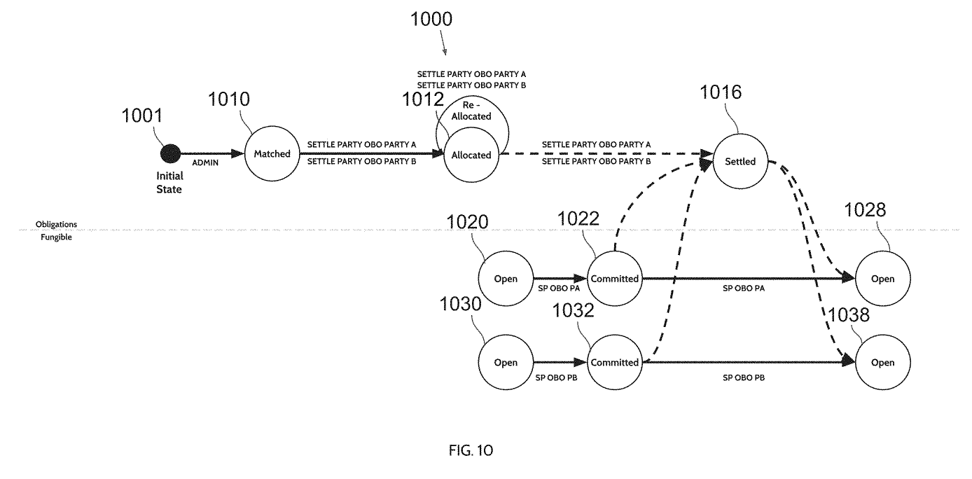

As shown in FIG. 10, a state diagram for Clearing and Settlement (C&S) Workflow, Variant 4 (V4), is indicated generally by the reference numeral 1000. Here, reference numerals 1001-1016 (above the dashed line) refer to the states of obligations, while reference numerals 1020-1038 (below the dashed line) refer to the states of fungible assets.

An Initial State 1001, with respect to a transaction comprising at least one bundle of obligations, is transitioned by ADMIN to a Matched state 1010. The obligations of PARTY A and PARTY B are each transitioned by a respective settlement party on behalf of PARTY A and PARTY B from the Matched state to an Allocated state 1012, and may be re-allocated as needed by the respective settlement party on behalf of PARTY A and PARTY B.

PARTY A's fungible asset is placed in an Open account state 1020, and transitioned to a Committed account state 1022 by a Settlement Party on behalf of (OBO) PARTY A (PA). PARTY B's fungible asset is placed in an Open account state 1030, and transitioned to a Committed account state 1032 by a Settlement Party on behalf of (OBO) PARTY B (PB). Once all necessary fungible assets are in Committed account states, the obligations state may be transitioned from the Allocated state to a Settled state 1016 by a Settlement Party on behalf of PARTY A and a Settlement Party on behalf of PARTY B, each for their respective fungible assets. Once settled, Party A's original asset is moved to an Open account state 1028, and Party B's original asset is moved to an Open account state 1038.

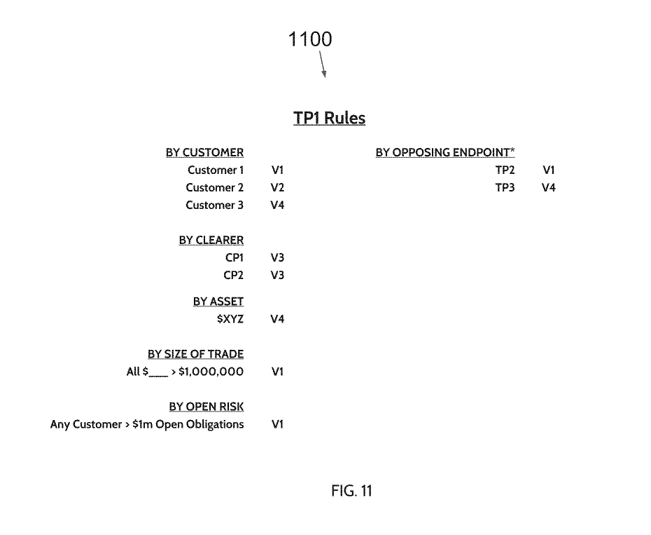

Turning to FIG. 11, one of Variants 1, 2, 3, and 4 of FIGS. 7, 8, 9, and 10, respectively, may be selected for each transaction based on TP1 Rules indicated generally by the reference numeral 1100. The Variant used may be selected by customer (e.g., V1 for Customer 1, V2 for Customer 2, V3 for Customer 3), by clearer (e.g., V3 for CP1 or CP2), by asset (e.g., V4 for $XYZ), by size of trade (e.g., all trades over $1,000,000), by open risk (e.g., V1 for any customer with over $1,000,000 worth of open obligations), or by opposing endpoint (e.g., V1 for TP2, V2 for TP3). Here, a differential for workflow based on opposing endpoint may be useful for the optionality around a credit-based net or settlement.

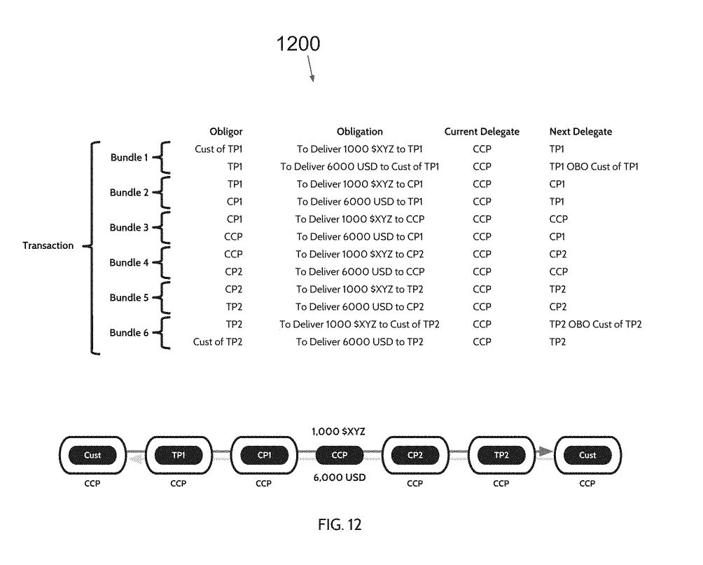

Turning now to FIG. 12, an exchange traded match action is indicated generally by the reference numeral 1200. Here, a transaction includes six bundles denoted Bundle 1 through Bundle 6.

Bundle 1 includes a first obligation of trading participant TP1's Customer using a central counterparty clearinghouse CCP as current authorizer to transfer quantity 1000 of primary asset $XYZ to TP1. The bundle includes a second obligation of TP1 using the CCP as authorizer to transfer quantity 6000 of secondary asset USD to TP1's Customer, where the next authorizer is SP1 on behalf of Issuer.

Bundle 2 includes a first obligation of TP1 using the CCP as authorizer to transfer quantity 1000 of primary asset $XYZ to clearing participant CP1. The bundle includes a second obligation of CP1 using the CCP as authorizer to transfer quantity 6000 of secondary asset USD to TP1.

Bundle 3 includes a first obligation of CP1 using the CCP as authorizer to transfer quantity 1000 of primary asset $XYZ to CCP. The bundle includes a second obligation of CCP using itself as authorizer to transfer quantity 6000 of secondary asset USD to CP1.

Bundle 4 includes a first obligation of CCP using itself as authorizer to transfer quantity 1000 of primary asset $XYZ to clearing participant CP2. The bundle includes a second obligation of CP2 using the CCP as authorizer to transfer quantity 6000 of secondary asset USD to trading participant TP2.

Bundle 5 includes a first obligation of CP2 using the CCP as authorizer to transfer quantity 1000 of primary asset $XYZ to TP2. The bundle includes a second obligation of TP2 using the CCP as authorizer to transfer quantity 6000 of secondary asset USD to CP2.

Bundle 6 includes a first obligation of TP2 using CCP as authorizer to transfer quantity 1000 of primary asset $XYZ to TP2'S Customer, where the next authorizer is TP2 on behalf of TP2's Customer. The bundle includes a second obligation of TP2's Customer using the CCP as authorizer to transfer quantity 6000 of secondary asset USD to TP2.

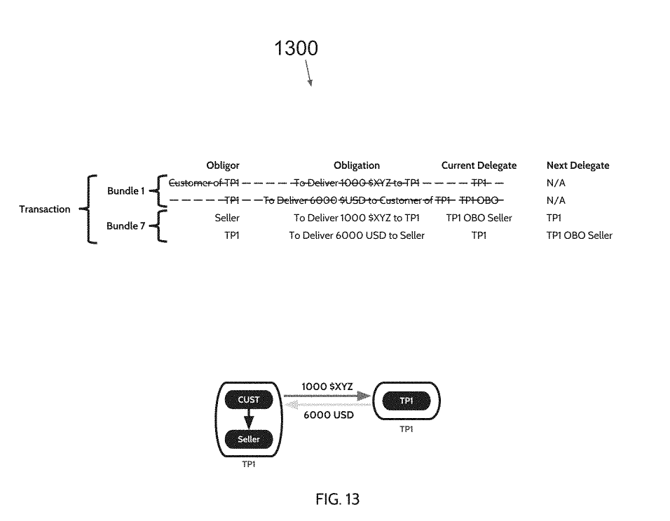

As shown in FIG. 13, an allocation action is indicated generally by the reference numeral 1300. Here, a transaction includes a first Bundle 1 and a second Bundle 2.

Bundle 1 includes a first obligation of TP1's Customer to deliver quantity 1000 of asset $XYZ to TP1 where the transfer authorizer is TP1, and the next authorizer is not applicable. The bundle includes a second obligation of TP1 to deliver quantity 6000 USD to TP1's Customer where the transfer authorizer is TP1 on behalf of TP1's Customer, and the next authorizer is not applicable. Here, Bundle 1 has been burned or destroyed in favor of replacement Bundle 7

Bundle 7 includes a first obligation of Seller to deliver quantity 1000 of asset $XYZ to TP1 where TP1 on behalf of Seller is the transfer authorizer, and TP1 is the next authorizer. The bundle includes a second obligation of TP1 to deliver quantity 6000 of asset USD to Seller where TP1 is the transfer authorizer, and TP1 on behalf of Seller is the next authorizer.

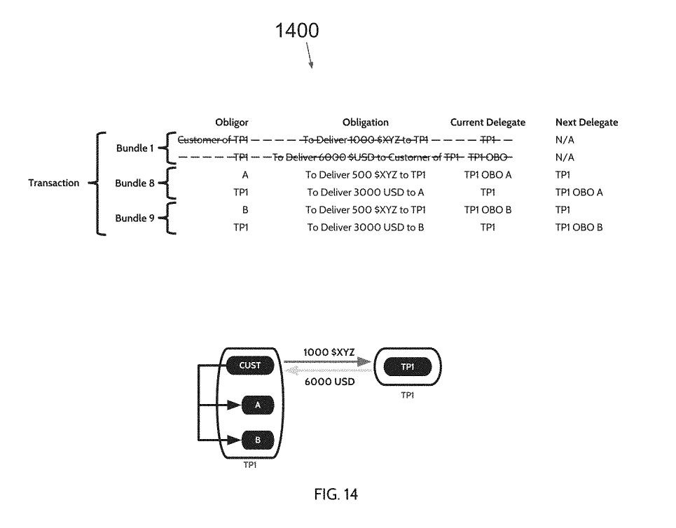

Turning to FIG. 14, a multi-action allocation is indicated generally by the reference numeral 1400. Here, a transaction includes Bundles 1, 8 and 9.

Bundle 1 includes a first obligation of TP1's Customer to deliver quantity 1000 of asset $XYZ to TP1 where the transfer authorizer is TP1, and the next authorizer is not applicable. The bundle includes a second obligation of TP1 to deliver quantity 6000 USD to TP1's Customer where the transfer authorizer is TP1 on behalf of TP1's Customer, and the next authorizer is not applicable. Here, Bundle 1 has been burned or destroyed in favor of replacement Bundles 8 and 9.

Bundle 8 includes a first obligation of A to deliver quantity 500 of asset $XYZ to TP1 where TP1 on behalf of A is the transfer authorizer, and TP1 is the next authorizer. The bundle includes a second obligation of TP1 to deliver quantity 3000 of asset USD to TP1 where TP1 is the transfer authorizer, and TP1 on behalf of A is the next authorizer.

Bundle 9 includes a first obligation of B to deliver quantity 500 of asset $XYZ to TP1 where TP1 on behalf of B is the transfer authorizer, and TP1 is the next authorizer. The bundle includes a second obligation of TP1 to deliver quantity 3000 of asset USD to TP1 where TP1 is the transfer authorizer, and TP1 on behalf of B is the next authorizer.

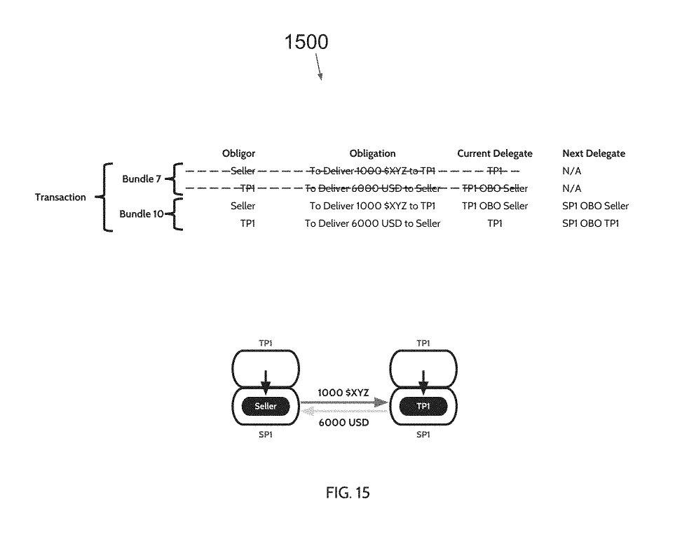

Turning now to FIG. 15, a ready for settle action is indicated generally by the reference numeral 1500. Here, a transaction includes Bundles 7 and 10.

Bundle 7 includes a first obligation of Seller to deliver quantity 1000 of asset $XYZ to TP1 where TP1 on behalf of Seller is the transfer authorizer, and TP1 is the next authorizer. The bundle includes a second obligation of TP1 to deliver quantity 6000 of asset USD to Seller where TP1 is the transfer authorizer, and TP1 on behalf of Seller is the next authorizer. Here, Bundle 7 has been burned in favor of Bundle 10.

Bundle 10 includes a first obligation of Seller to deliver quantity 1000 of $XYZ to TP1, where the transfer authorizer is TP1 on behalf of Seller and the next authorizer is SP1. The bundle includes a second obligation of TP1 to deliver quantity 6000 of USD to Seller where TP1 is the transfer authorizer and SP1 is the next authorizer.

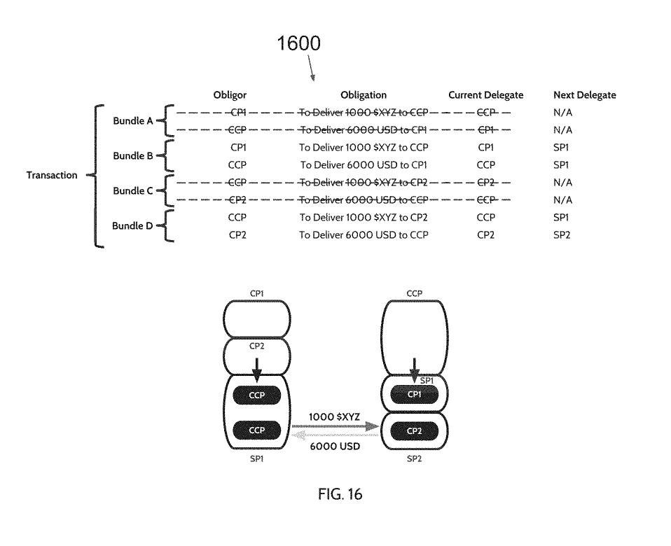

As shown in FIG. 16, another ready for settle action is indicated generally by the reference numeral 1600. A transaction includes Bundles A, B, C and D. Here, each participant has its custodian (SP1 or SP2, respectively), and the CCP uses SP1.

The first Bundle A includes a first obligation of clearing participant CP1 to deliver quantity 1000 of $XYZ asset to central counterparty clearinghouse CCP where CCP is the current authorizer and the next authorizer is not applicable. Bundle A includes a second obligation of CCP to deliver quantity 6000 of fungible asset USD to CP1 where CP1 is the current authorizer and the next authorizer is not applicable. Here, Bundle A is burned in favor of Bundle B.

The second Bundle B includes a first obligation of clearing participant CP1 to deliver quantity 1000 of $XYZ asset to CCP where CP1 is the current authorizer and the next authorizer is settlement participant SP1. Bundle B includes a second obligation of CCP to deliver quantity 6000 of fungible asset USD to CP1 where CCP is the current authorizer and the next authorizer is SP1.

The third Bundle C includes a first obligation of CCP to deliver quantity 1000 of $XYZ asset to CP2 where CP2 is the current authorizer and the next authorizer is not applicable. Bundle C includes a second obligation of CP2 to deliver quantity 6000 of fungible asset USD to CCP where CCP is the current authorizer and the next authorizer is not applicable. Here, Bundle C is burned in favor of Bundle D.

The fourth Bundle D includes a first obligation of CCP to deliver quantity 1000 of asset $XYZ to CP2 where CCP is the current authorizer and the next authorizer is SP2. Bundle B includes a second obligation of CCP to deliver quantity 6000 of fungible asset USD to CCP where CP2 is the current authorizer and the next authorizer is SP2.

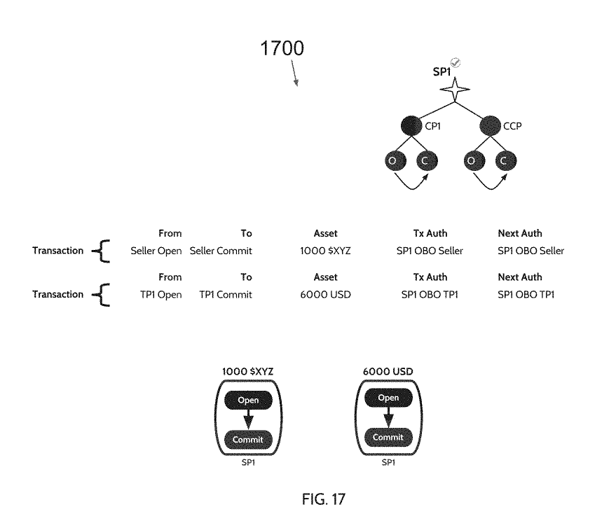

Turning to FIG. 17, a commit action is indicated generally by the reference numeral 1700. The commit action includes two transactions.

Dealers may net out in the batch process, but in this example the customer has requested to settle immediately and the dealer has agreed to facilitate that. In this case, the dealer will deliver cash tokens to the seller and hold the asset.

The first transaction comprises a transfer from Seller's Open account to Seller's Commit account of quantity 1000 of asset $XYZ, where both the current and next authorizers are SP1 on behalf of Seller. The second comprises a transfer from TP1's Open account to TP1's Commit account of quantity 6000 of asset USD, where both the current and next authorizers are SP1 on behalf of TP1.

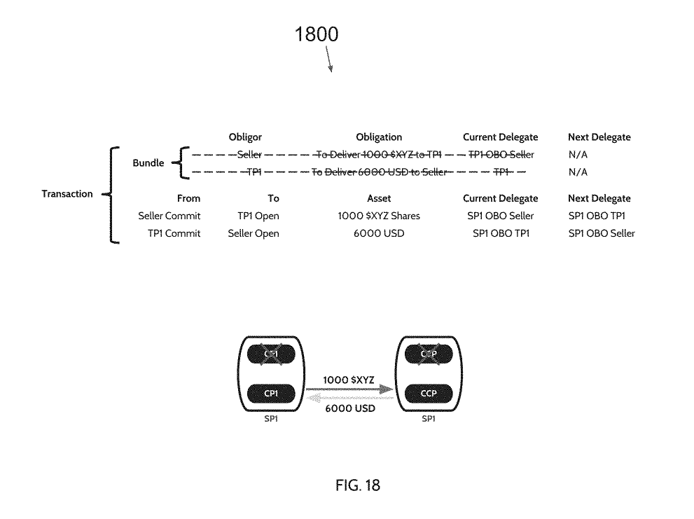

Turning now to FIG. 18, a settle action is indicated generally by the reference numeral 1800. Here, the transaction includes an obligation Bundle to be burned and a transaction pair.

The Bundle includes a first obligation of Seller to deliver quantity 1000 of asset $XYZ to trading participant TP1, where the transfer authorizer is TP1 on behalf of Seller and the next authorizer is not applicable. The Bundle includes a second obligation of TP1 to deliver quantity 6000 of USD to Seller, where the transfer authorizer is TP1 and the next authorizer is not applicable.

The transaction pair includes a first transfer leg from Seller's Commit account to TP1's Open account of 1000 shares of dollar denominated asset $XYZ, where the transfer authorizer is SP1 on behalf of Seller and the next authorizer is SP1 on behalf of TP1. The transaction pair includes a second transfer leg from TP1's Commit account to Seller's Open account of 6000 USD, where the transfer authorizer is SP1 on behalf of TP1 and the next authorizer is SP1 on behalf of Seller.

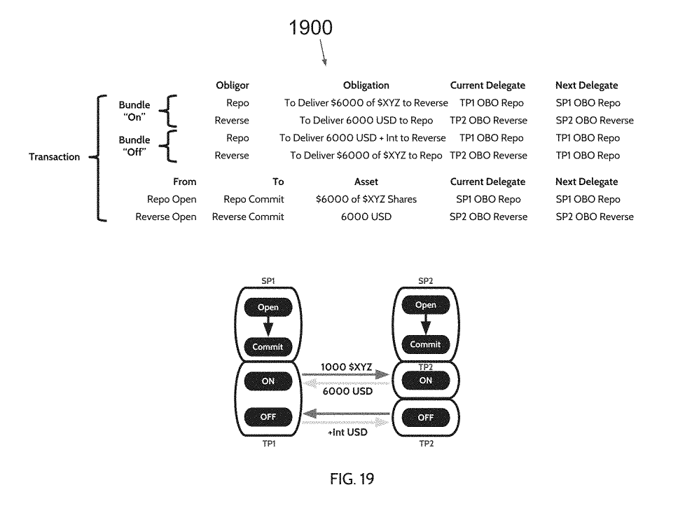

As shown in FIG. 19, a repo with immediate settlement action is indicated generally by the reference numeral 1900. Here, a transaction includes a Bundle On leg, a Bundle Off leg, and a pair of transfers.

The Bundle On leg includes a first obligation of Repo to deliver $6000 OF $XYZ to Reverse, where the transfer authorizer is TP1 on behalf of Repo and the next authorizer is SP1 on behalf of Repo (cash borrower, shares lender). The Bundle On includes a second obligation of Reverse to deliver 6000 USD to Repo, where the transfer authorizer is TP2 on behalf of Reverse and the next authorizer is SP2 on behalf of Reverse (cash lender, shares borrower). Repo always trades in dollar ($) quantity of an asset. Here, the obligation is defined as $6000 OF $XYZ and this transaction assumes an ‘anchor price’ of $6, which may be set or the market price of the asset so that it may be determined how many shares are included in the transaction. Partial shares can't move, so the dollar ($) amount may be tweaked to the nearest integer of shares meeting the minimum required borrow amount.

The Bundle Off leg includes a first obligation of Repo to deliver 6000 USD plus interest to Reverse, where the transfer authorizer is TP1 on behalf of Repo and the next authorizer is TP1 on behalf of Repo. The Bundle Off leg includes a second obligation of Reverse to deliver $6000 OF $XYZ to Repo, where the transfer authorizer is TP2 on behalf of Reverse and the next authorizer is TP1 on behalf of Repo. In order to advance a Repo obligation, the lender of the asset maintains the right to call back the lent asset independent of the borrower. Thus, the lender of the asset holds both obligations on the Off leg.

The first transfer is from Repo's Open account to Repo's Commit account for $6000 worth of $XYZ shares, where both the transfer and next authorizers are SP1 on behalf of Repo. The second transfer is from Reverse's Open account to Reverse's Commit account for 6000 USD, where both the transfer authorizer and the next authorizer are SP2 on behalf of Reverse.

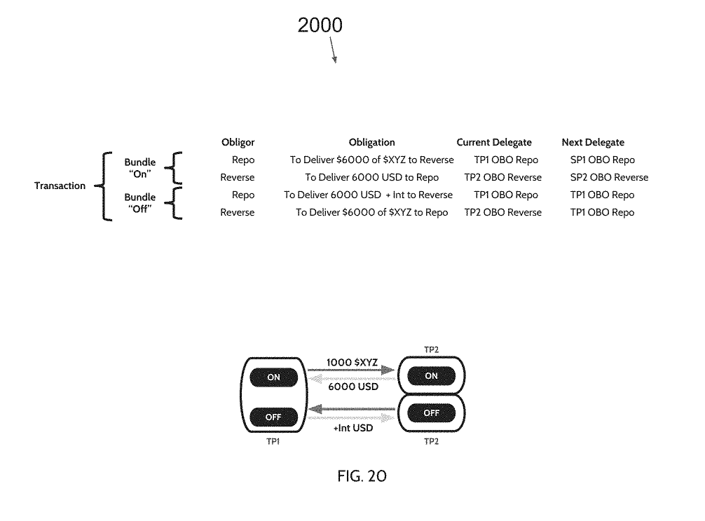

Turning to FIG. 20, a repo with as soon as possible settlement action is indicated generally by the reference numeral 2000. Here, a transaction includes a Bundle On leg and a Bundle Off leg.

The Bundle On leg includes a first obligation of Repo (cash borrower, shares lender) to deliver $6000 OF $XYZ to Reverse (cash lender, shares borrower), where the current authorizer (transfer authorizer) is TP1 on behalf of Repo and the next authorizer is SP1 on behalf of Repo. The Bundle On leg includes a second obligation of Reverse to deliver 6000 USD to Repo, where the current authorizer is TP2 on behalf of Reverse and the next authorizer is SP2 on behalf of Reverse.

The Bundle Off leg includes a first obligation of Repo to deliver 6000 USD plus interest to Reverse, where the transfer authorizer is TP1 on behalf of Repo and the next authorizer is TP1 on behalf of Reverse. The Bundle Off leg includes a second obligation of Reverse to deliver $6000 worth of $XYZ to Repo, where the transfer authorizer is TP2 on behalf of Reverse and the next authorizer is TP1 on behalf of Repo.

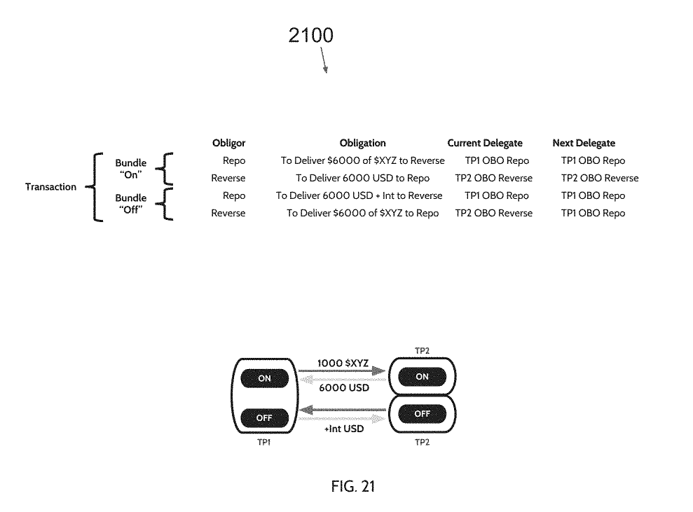

Turning now to FIG. 21, a repo with end-of-day (EOD) settlement action is indicated generally by the reference numeral 2100. Here, a transaction includes a Bundle On leg and a Bundle Off leg.

The Bundle On leg includes a first obligation of Repo (cash borrower, shares lender) to deliver $6000 OF $XYZ to Reverse (cash lender, shares borrower), where the current authorizer (transfer authorizer) is TP1 on behalf of Repo and the next authorizer is TP1 on behalf of Repo. The Bundle On leg includes a second obligation of Reverse to deliver 6000 USD to Repo, where the current authorizer is TP2 on behalf of Reverse and the next authorizer is TP2 on behalf of Reverse.

The Bundle Off leg includes a first obligation of Repo to deliver 6000 USD plus interest to Reverse, where the transfer authorizer is TP1 on behalf of Repo and the next authorizer is TP1 on behalf of Reverse. The Bundle Off leg includes a second obligation of Reverse to deliver $6000 OF $XYZ to Repo, where the current authorizer is TP2 on behalf of Reverse and the next authorizer is TP1 on behalf of Repo.

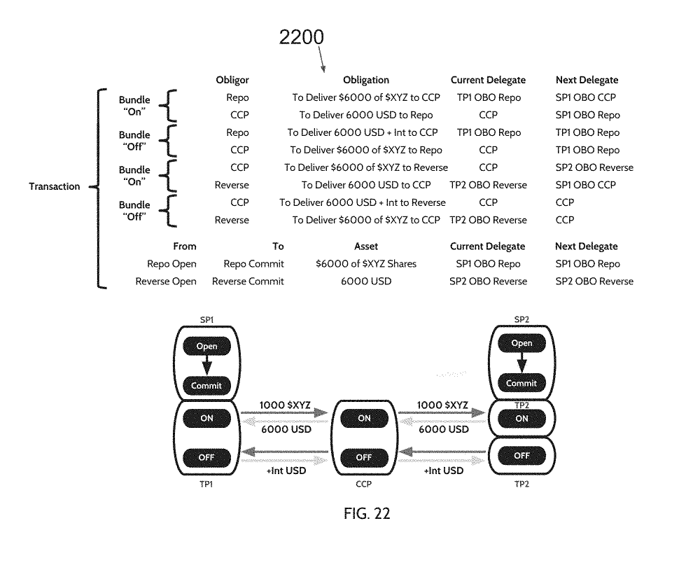

As shown in FIG. 22, a repo action with immediate settlement and CCP clearance is indicated generally by the reference numeral 2200. Here, a transaction includes a first Bundle On leg, a first Bundle Off leg, a second Bundle On leg, a second Bundle Off leg, and a pair or transfers.

The first Bundle On leg includes a first obligation of Repo (cash borrower, shares lender) to deliver $6000 OF $XYZ to CCP, where the current authorizer is TP1 on behalf of Repo and the next authorizer is SP1 on behalf of CCP. The first Bundle On leg includes a second obligation of CCP to deliver 6000 USD to Repo, where the current authorizer is CCP and the next authorizer is SP1 on behalf of Repo.

The first Bundle Off leg includes a first obligation of Repo to deliver 6000 USD plus interest to CCP, where both the current authorizer and next authorizer are TP1 on behalf of Repo. The first Bundle Off leg includes a second obligation of CCP to deliver $6000 OF $XYZ to Repo, where the current authorizer is CCP and the next authorizer is TP1 on behalf of Repo. In order to advance a Repo obligation, the lender of the asset shares maintains the right to call back the lent asset independent of the borrower. Thus, the lender of the asset holds both obligations as next authorizer on the Off leg.

The second Bundle On leg includes a first obligation of CCP to deliver $6000 OF $XYZ to Reverse (cash lender, shares borrower), where the current authorizer is CCP and the next authorizer is SP2 on behalf of Reverse. The second Bundle On leg includes a second obligation of Reverse to deliver 6000 USD to CCP, where the current authorizer is TP2 on behalf of Reverse and the next authorizer is SP1 on behalf of CCP.

The second Bundle Off leg includes a first obligation of CCP to deliver 6000 USD plus interest to Reverse, where both the current authorizer and next authorizer are CCP. The second Bundle Off leg includes a second obligation of Reverse to deliver $6000 OF $XYZ to CCP, where the current authorizer is TP2 on behalf of Reverse and the next authorizer is CCP.

The first transfer is from Repo's Open account to Repo's Commit account for $6000 worth of $XYZ shares, where both the current and next authorizers are SP1 on behalf of Repo (cash borrower, shares lender). The second transfer is from Reverse's Open account to Reverse's Commit account for 6000 USD, where both the transfer authorizer and the next authorizer are SP2 on behalf of Reverse (cash lender, shares borrower).

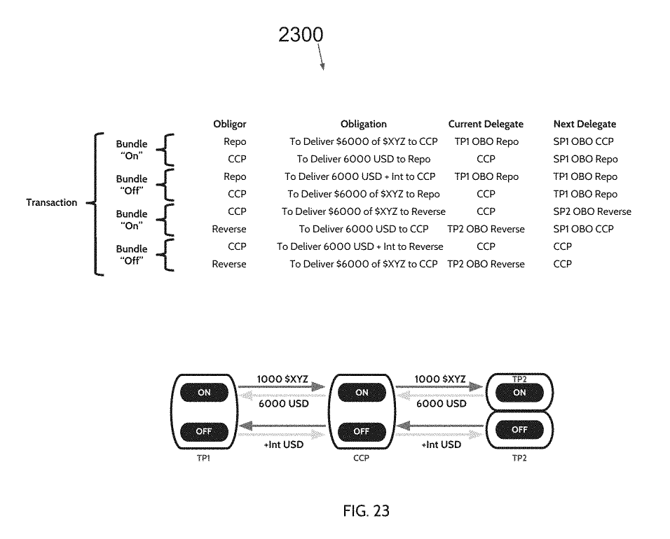

Turning to FIG. 23, a repo action with as-soon-as-possible (ASAP) settlement and CCP clearance is indicated generally by the reference numeral 2300. Here, a transaction includes a first Bundle On leg, a first Bundle Off leg, a second Bundle On leg, and a second Bundle Off leg.

The first Bundle On leg includes a first obligation of Repo (cash borrower, shares lender) to deliver $6000 OF $XYZ to CCP, where the current authorizer is TP1 on behalf of Repo and the next authorizer is SP1 on behalf of CCP. The first Bundle On leg includes a second obligation of CCP to deliver 6000 USD to Repo, where the current authorizer is CCP and the next authorizer is SP1 on behalf of Repo.

The first Bundle Off leg includes a first obligation of Repo to deliver 6000 USD plus interest to CCP, where both the current authorizer and next authorizer are TP1 on behalf of Repo. The first Bundle Off leg includes a second obligation of CCP to deliver $6000 OF $XYZ to Repo, where the current authorizer is CCP and the next authorizer is TP1 on behalf of Repo. In order to advance a Repo obligation, the lender of the asset shares maintains the right to call back the lent asset independent of the borrower. Thus, the lender of the asset holds both obligations as next authorizer on the Off leg.

The second Bundle On leg includes a first obligation of CCP to deliver $6000 OF $XYZ to Reverse (cash lender, shares borrower), where the current authorizer is CCP and the next authorizer is SP2 on behalf of Reverse. The second Bundle On leg includes a second obligation of Reverse to deliver 6000 USD to CCP, where the current authorizer is TP2 on behalf of Reverse and the next authorizer is SP1 on behalf of CCP.

The second Bundle Off leg includes a first obligation of CCP to deliver 6000 USD plus interest to Reverse, where both the current authorizer and next authorizer are CCP. The second Bundle Off leg includes a second obligation of Reverse to deliver $6000 OF $XYZ to CCP, where the current authorizer is TP2 on behalf of Reverse and the next authorizer is CCP.

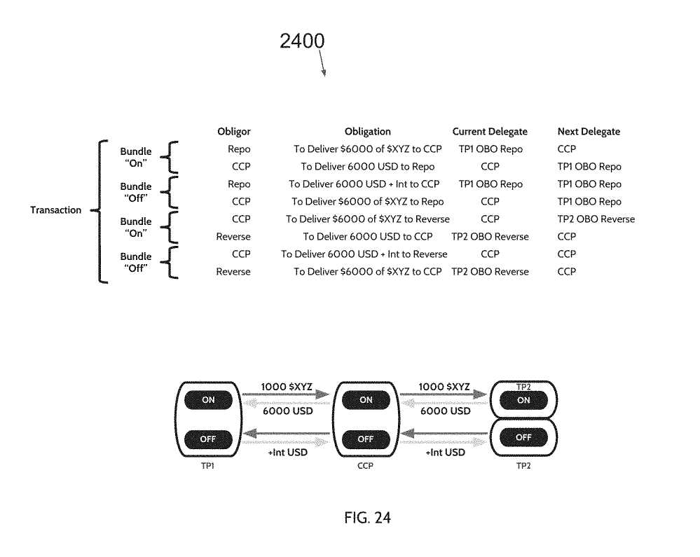

Turning now to FIG. 24, a repo action with end-of-day (EOD) settlement and CCP clearance is indicated generally by the reference numeral 2400. Here, a transaction includes a first Bundle On leg, a first Bundle Off leg, a second Bundle On leg, and a second Bundle Off leg.

The first Bundle On leg includes a first obligation of Repo (cash borrower, shares lender) to deliver $6000 OF $XYZ to CCP, where the current authorizer is TP1 on behalf of Repo and the next authorizer is CCP. The first Bundle On leg includes a second obligation of CCP to deliver 6000 USD to Repo, where the current authorizer is CCP and the next authorizer is TP1 on behalf of Repo.

The first Bundle Off leg includes a first obligation of Repo to deliver 6000 USD plus interest to CCP, where both the current authorizer and next authorizer are TP1 on behalf of Repo. The first Bundle Off leg includes a second obligation of CCP to deliver $6000 OF $XYZ to Repo, where the current authorizer is CCP and the next authorizer is TP1 on behalf of Repo. In order to advance a Repo obligation, the lender of the asset maintains the right to call back the lent asset independent of the borrower. Thus, the lender of the asset holds both obligations as next authorizer on the Off leg.

The second Bundle On leg includes a first obligation of CCP to deliver $6000 OF $XYZ to Reverse (cash lender, shares borrower), where the current authorizer is CCP and the next authorizer is TP2 on behalf of Reverse. The second Bundle On leg includes a second obligation of Reverse to deliver 6000 USD to CCP, where the current authorizer is TP2 on behalf of Reverse and the next authorizer is CCP.

The second Bundle Off leg includes a first obligation of CCP to deliver 6000 USD plus interest to Reverse, where both the current authorizer and next authorizer are CCP. The second Bundle Off leg includes a second obligation of Reverse to deliver $6000 OF $XYZ to CCP, where the current authorizer is TP2 on behalf of Reverse and the next authorizer is CCP.

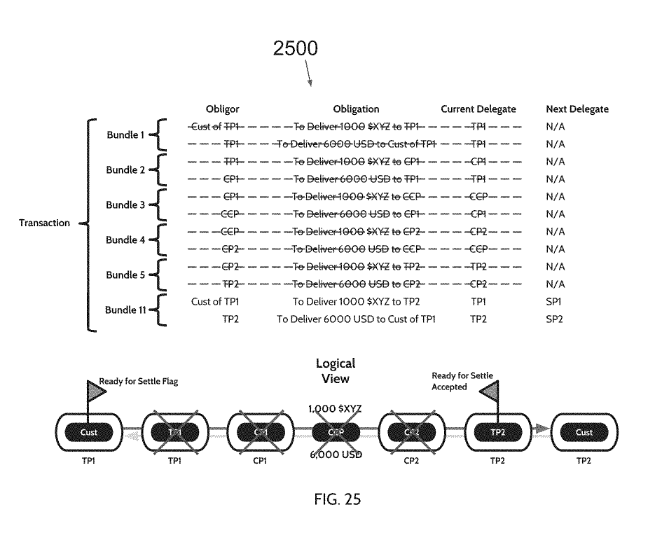

As shown in FIG. 25, an obligations reduction action is indicated generally by the reference numeral 2500. If ‘Ready for Settle’ is flagged and an existing participant accepts, this can trigger a reduction in overall obligations. Here, a transaction includes Bundles 1 through 5, which are obviated and destroyed, and a new Bundle 11.

Bundle 1 includes a first obligation of trading participant TP1's Customer to transfer quantity 1000 of asset $XYZ to TP1, where the current authorizer is TP1 and the next authorizer is not applicable. The bundle includes a second obligation of TP1 to transfer 6000 USD to TP1's Customer, where the current authorizer is TP1 and the next authorizer is not applicable. The strike-throughs indicate that both obligations have been obviated and destroyed.

Bundle 2 includes a first obligation of TP1 to transfer quantity 1000 of primary asset $XYZ to clearing participant CP1, where the current authorizer is CP1 and next authorizer is not applicable. The bundle includes a second obligation of CP1 to transfer 6000 USD to TP1, where the current authorizer is TP1 and the next authorizer is not applicable. The strike-throughs indicate that both obligations have been obviated and destroyed.

Bundle 3 includes a first obligation of CP1 to transfer quantity 1000 of asset $XYZ to central counterparty clearinghouse CCP, where the current authorizer is CCP and the next authorizer is not applicable. The bundle includes a second obligation of CCP to deliver 6000 USD to CP1, where the current authorizer is CP1 and the next authorizer is not applicable. The strike-throughs indicate that both obligations have been obviated and destroyed.

Bundle 4 includes a first obligation of CCP to deliver quantity 1000 of asset $XYZ to clearing participant CP2, where the current authorizer is CP2 and the next authorizer is not applicable. The bundle includes a second obligation of CP2 to deliver 6000 USD to CCP, where the current authorizer is CCP and the next authorizer is not applicable. The strike-throughs indicate that both obligations have been obviated and destroyed.

Bundle 5 includes a first obligation of CP2 to deliver quantity 1000 of asset $XYZ to trading participant TP2, where the current authorizer is TP2 and the next authorizer is not applicable. The bundle includes a second obligation of TP2 to transfer 6000 USD to CP2, where the current authorizer is CP2 and the next authorizer is not applicable. The strike-throughs indicate that both obligations have been obviated and destroyed.

New Bundle 11 includes a first obligation of TP1's Customer to transfer quantity 1000 of asset $XYZ to TP2, where the current authorizer is TP1 and the next authorizer is settlement participant SP1. The new bundle includes a second obligation of TP2 to transfer 6000 USD to TP1's Customer, where the current authorizer is TP2 and the next authorizer is settlement participant SP2.

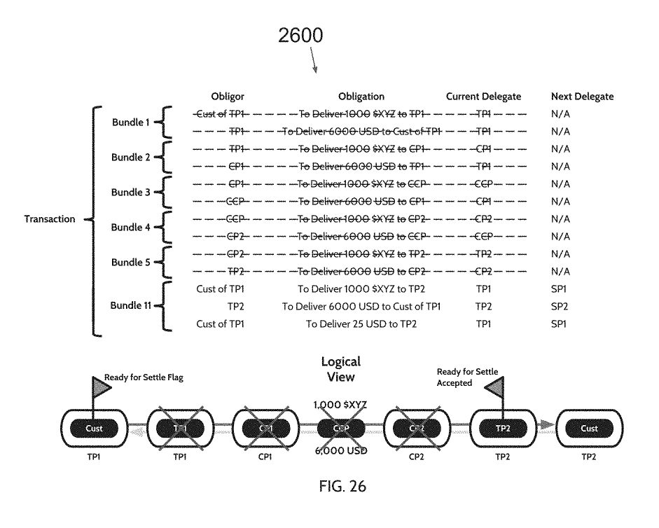

Turning to FIG. 26, an obligations reduction with preference fee action is indicated generally by the reference numeral 2600. If ‘Ready for Settle’ is flagged and an existing participant accepts, this can trigger a reduction in overall obligations. Moreover, preference can be expressed with a fee or price to be paid for the preference. Here, a transaction includes Bundles 1 through 5, which are obviated and destroyed as in the previous figure, and a new Bundle 11.

Bundle 1 includes a first obligation of trading participant TP1's Customer to transfer quantity 1000 of asset $XYZ to TP1, where the current authorizer is TP1 and the next authorizer is not applicable. The bundle includes a second obligation of TP1 to transfer 6000 USD to TP1's Customer, where the current authorizer is TP1 and the next authorizer is not applicable. The strike-throughs indicate that both obligations have been obviated and destroyed.

Bundle 2 includes a first obligation of TP1 to transfer quantity 1000 of asset $XYZ to clearing participant CP1, where the current authorizer is CP1 and next authorizer is not applicable. The bundle includes a second obligation of CP1 to transfer 6000 USD to TP1, where the current authorizer is TP1 and the next authorizer is not applicable. The strike-throughs indicate that both obligations have been obviated and destroyed.

Bundle 3 includes a first obligation of CP1 to transfer quantity 1000 of asset $XYZ to central counterparty clearinghouse CCP, where the current authorizer is CCP and the next authorizer is not applicable. The bundle includes a second obligation of CCP to deliver 6000 USD to CP1, where the current authorizer is CP1 and the next authorizer is not applicable. The strike-throughs indicate that both obligations have been obviated and destroyed.

Bundle 4 includes a first obligation of CCP to deliver quantity 1000 of asset $XYZ to clearing participant CP2, where the current authorizer is CP2 and the next authorizer is not applicable. The bundle includes a second obligation of CP2 to deliver 6000 USD to CCP, where the current authorizer is CCP and the next authorizer is not applicable. The strike-throughs indicate that both obligations have been obviated and destroyed.

Bundle 5 includes a first obligation of CP2 to deliver quantity 1000 of asset $XYZ to trading participant TP2, where the current authorizer is TP2 and the next authorizer is not applicable. The bundle includes a second obligation of TP2 to transfer 6000 USD to CP2, where the current authorizer is CP2 and the next authorizer is not applicable. The strike-throughs indicate that both obligations have been obviated and destroyed.

New Bundle 11 includes a first obligation of TP1's Customer to transfer quantity 1000 of asset $XYZ to TP2, where the current authorizer is TP1 and the next authorizer is settlement participant SP1. The new bundle includes a second obligation of TP2 to transfer 6000 USD to TP1's Customer, where the current authorizer is TP2 and the next authorizer is settlement participant SP2. The new bundle includes a third obligation of TP1's Customer to transfer 25 USD to TP2, where the current authorizer is TP1 and the next authorizer is SP1.

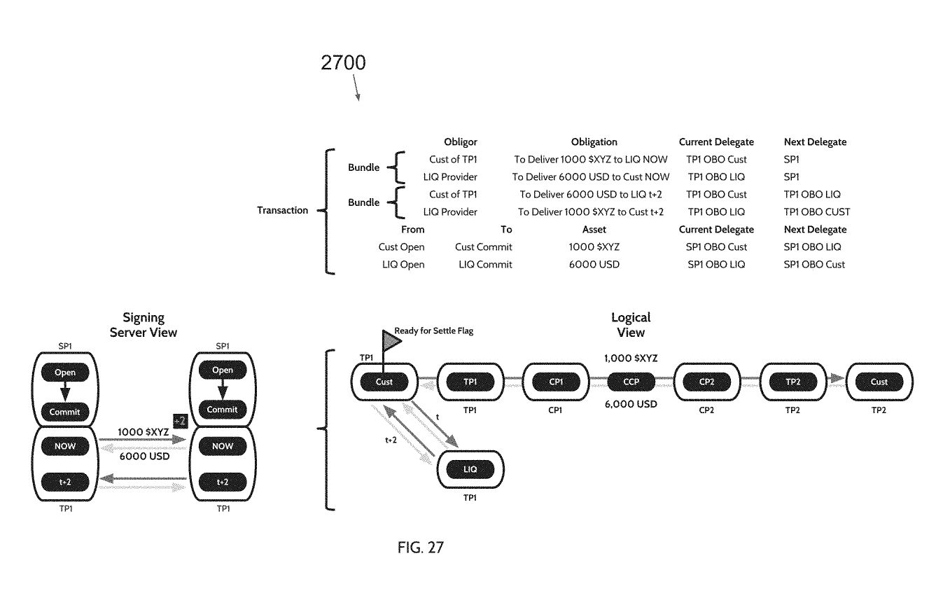

Turning now to FIG. 27, a settlement liquidity action is indicated generally by the reference numeral 2700. Here, if an existing counterparty or intermediary does not accept early settlement, a separate participant can step in and offer settlement liquidity. Here, a transaction includes two Bundles and two transfers.

The first Bundle includes a first obligation of TP1's Customer to deliver 1000 $XYZ shares to the Liquidity Provider at time NOW, where the current authorizer is TP1 on behalf of TP1's Customer and the next authorizer is SP1. The bundle includes a second obligation of the Liquidity Provider to deliver 6000 USD to Customer at time NOW, where the current authorizer is TP1 on behalf of the Liquidity Provider and the next authorizer is SP1.

The second Bundle includes a first obligation of TP1's Customer to deliver 6000 USD to the Liquidity Provider at time t+2, where the current authorizer is TP1 on behalf of TP1's Customer and the next authorizer is TP1 on behalf of the Liquidity Provider. The bundle includes a second obligation of the Liquidity Provider to deliver 1000 $XYZ shares to Customer at time t+2, where the current authorizer is TP1 on behalf of the Liquidity Provider and the next authorizer is TP1 on behalf of Customer.

The first transfer is from TP1 Customer's Open account to TP1 Customer's Commit account of 1000 $XYZ shares, where the current authorizer is SP1 on behalf of TP1's Customer and the next authorizer is SP1 on behalf of the Liquidity Provider. The second transfer is from the Liquidity Provider's Open account to the Liquidity Provider's Commit account of 6000 USD, where the current authorizer is SP1 on behalf of the Liquidity Provider and the next authorizer is SP1 on behalf of TP1's Customer.

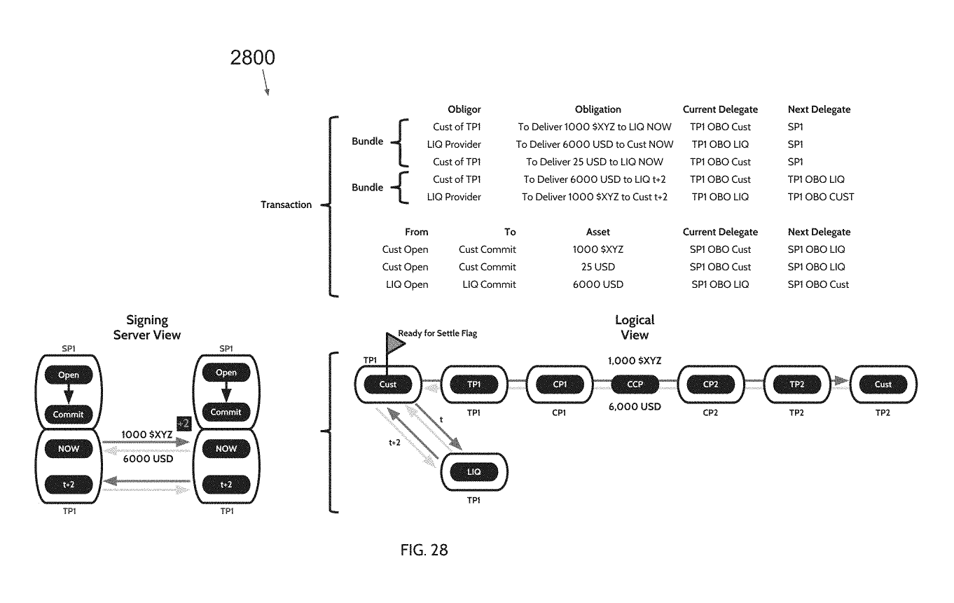

Turning now to FIG. 28, a settlement liquidity action with preference fee is indicated generally by the reference numeral 2800. Here, if an existing counterparty or intermediary does not accept early settlement, a separate participant can step in and offer settlement liquidity and the preference can include a fee on the immediate settlement. Here, a transaction includes two Bundles and three transfers.

The first Bundle includes a first obligation of TP1's Customer to deliver 1000 $XYZ shares to the Liquidity Provider at time NOW, where the current authorizer is TP1 on behalf of TP1's Customer and the next authorizer is SP1. The bundle includes a second obligation of the Liquidity Provider to deliver 6000 USD to Customer at time NOW, where the current authorizer is TP1 on behalf of the Liquidity Provider and the next authorizer is SP1. The bundle includes a third obligation of TP1's Customer to deliver 25 USD to the Liquidity Provider at time NOW, where the current authorizer is TP1 on behalf of TP1's Customer and the next authorizer is SP1.

The second Bundle includes a first obligation of TP1's Customer to deliver 6000 USD to the Liquidity Provider at time t+2, where the current authorizer is TP1 on behalf of TP1's Customer and the next authorizer is TP1 on behalf of the Liquidity Provider. The bundle includes a second obligation of the Liquidity Provider to deliver 1000 $XYZ shares to Customer at time t+2, where the current authorizer is TP1 on behalf of the Liquidity Provider and the next authorizer is TP1 on behalf of Customer.

The first transfer is from TP1 Customer's Open account to TP1 Customer's Commit account of 1000 $XYZ shares, where the current authorizer is SP1 on behalf of TP1's Customer and the next authorizer is SP1 on behalf of the Liquidity Provider. The second transfer is from TP1 Customer's Open account to TP1 Customer's Commit account of 25 USD, where the current authorizer is SP1 on behalf of TP1's Customer and the next authorizer is SP1 on behalf of the Liquidity Provider. The third transfer is from the Liquidity Provider's Open account to the Liquidity Provider's Commit account of 6000 USD, where the current authorizer is SP1 on behalf of the Liquidity Provider and the next authorizer is SP1 on behalf of TP1's Customer.

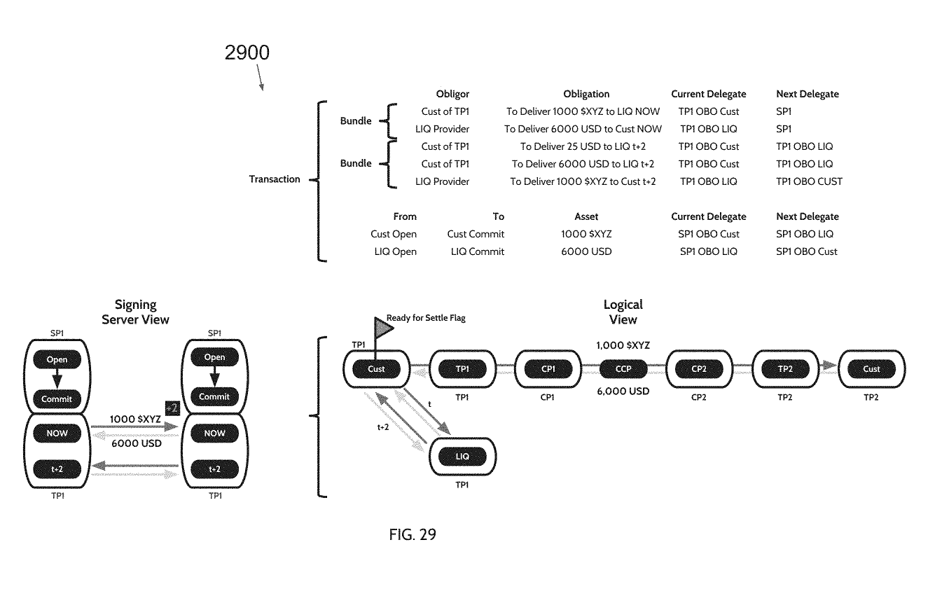

As shown in FIG. 29, a settlement liquidity action with preference fee is indicated generally by the reference numeral 2900. Here, if an existing counterparty or intermediary does not accept early settlement, a separate participant can step in and offer settlement liquidity and the preference can include a fee on the later dated obligation. Such a transaction includes two Bundles and two transfers.

The first Bundle includes a first obligation of TP1's Customer to deliver 1000 $XYZ shares to the Liquidity Provider at time NOW, where the current authorizer is TP1 on behalf of TP1's Customer and the next authorizer is SP1. The bundle includes a second obligation of the Liquidity Provider to deliver 6000 USD to Customer at time NOW, where the current authorizer is TP1 on behalf of the Liquidity Provider and the next authorizer is SP1.

The second Bundle includes a first obligation of TP1's Customer to deliver 25 USD to the Liquidity Provider at time t+2, where the current authorizer is TP1 on behalf of TP1's Customer and the next authorizer is TP1 on behalf of the Liquidity Provider. The bundle includes a second obligation of TP1's Customer to deliver 6000 USD to the Liquidity Provider at time t+2, where the current authorizer is TP1 on behalf of TP1's Customer and the next authorizer is TP1 on behalf of the Liquidity Provider. The bundle includes a third obligation of the Liquidity Provider to deliver 1000 $XYZ shares to Customer at time t+2, where the current authorizer is TP1 on behalf of the Liquidity Provider and the next authorizer is TP1 on behalf of Customer.

The first transfer is from TP1 Customer's Open account to TP1 Customer's Commit account of 1000 $XYZ shares, where the current authorizer is SP1 on behalf of TP1's Customer and the next authorizer is SP1 on behalf of the Liquidity Provider. The second transfer is from the Liquidity Provider's Open account to the Liquidity Provider's Commit account of 6000 USD, where the current authorizer is SP1 on behalf of the Liquidity Provider and the next authorizer is SP1 on behalf of TP1's Customer.

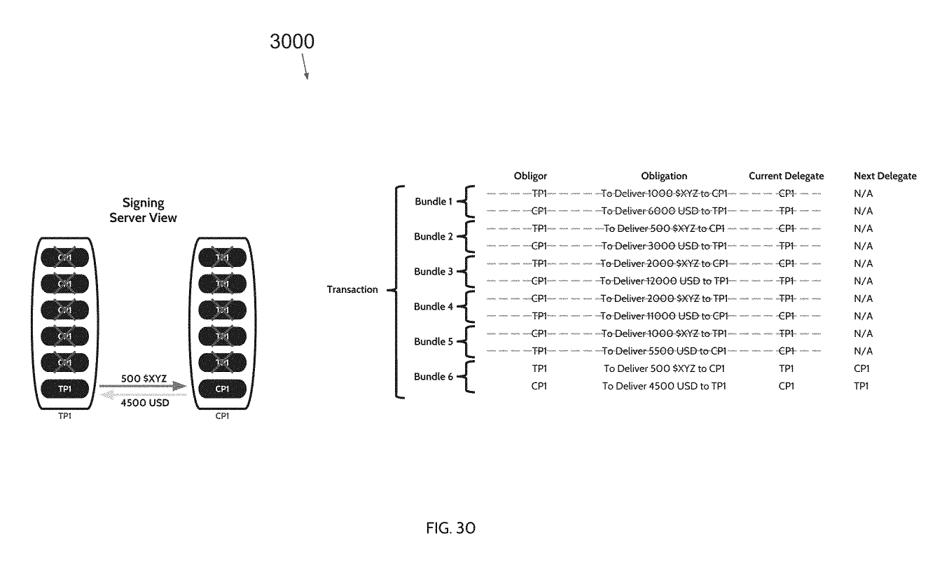

Turning to FIG. 30, a basic net action with bilateral, same name and same date attributes is indicated generally by the reference numeral 3000. Here, a transaction includes six bundles, Bundle 1 through Bundle 6.

Bundle 1 includes a first obligation of TP1 to deliver 1000 $XYZ shares to CP1, where the current authorizer is CP1, and the strike-through indicates that the obligation is destroyed so the next authorizer is not applicable. The bundle includes a second obligation of CP1 to deliver 6000 USD to TP1, where the current authorizer is TP1, and the strike-through indicates that the obligation is destroyed so the next authorizer is not applicable.

Bundle 2 includes a first obligation of TP1 to deliver 500 $XYZ shares to CP1, where the current authorizer is CP1, and the strike-through indicates that the obligation is destroyed so the next authorizer is not applicable. The bundle includes a second obligation of CP1 to deliver 3000 USD to TP1, where the current authorizer is TP1, and the strike-through indicates that the obligation is destroyed so the next authorizer is not applicable.

Bundle 3 includes a first obligation of TP1 to deliver 2000 $XYZ shares to CP1, where the current authorizer is CP1, and the strike-through indicates that the obligation is destroyed so the next authorizer is not applicable. The bundle includes a second obligation of CP1 to deliver 12000 USD to TP1, where the current authorizer is TP1, and the strike-through indicates that the obligation is destroyed so the next authorizer is not applicable.

Bundle 4 includes a first obligation of CP1 to deliver 2000 $XYZ shares to TP1, where the current authorizer is TP1, and the strike-through indicates that the obligation is destroyed so the next authorizer is not applicable. The bundle includes a second obligation of TP1 to deliver 11000 USD to CP1, where the current authorizer is CP1, and the strike-through indicates that the obligation is destroyed so the next authorizer is not applicable.

Bundle 5 includes a first obligation of CP1 to deliver 1000 $XYZ shares to TP1, where the current authorizer is TP1, and the strike-through indicates that the obligation is destroyed so the next authorizer is not applicable. The bundle includes a second obligation of TP1 to deliver 5500 USD to CP1, where the current authorizer is CP1, and the strike-through indicates that the obligation is destroyed so the next authorizer is not applicable.

Bundle 6, which is the net bundle, includes a first obligation of TP1 to deliver 500 $XYZ shares to CP1, where the current authorizer is TP1 and the next authorizer is CP1. The bundle includes a second obligation of CP1 to deliver 4500 USD to TP1, where the current authorizer is CP1 and the next authorizer is TP1.

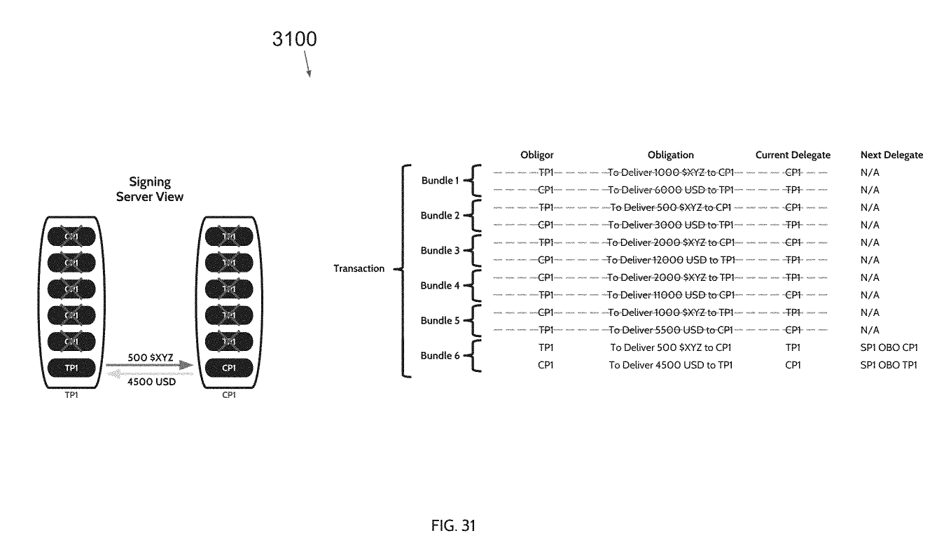

As shown in FIG. 31, an intermediate net action with bilateral, same name and same date attributes, and ‘Ready for Settle’ flag set, is indicated generally by the reference numeral 3100. Here, a transaction includes six bundles, Bundle 1 through Bundle 6.

Bundle 1 includes a first obligation of trading participant TP1 to deliver 1000 $XYZ shares to clearing participant CP1, where the current authorizer is CP1, and the strike-through indicates that the obligation is destroyed so the next authorizer is not applicable. The bundle includes a second obligation of CP1 to deliver 6000 USD to TP1, where the current authorizer is TP1, and the strike-through indicates that the obligation is destroyed so the next authorizer is not applicable.

Bundle 2 includes a first obligation of TP1 to deliver 500 $XYZ shares to CP1, where the current authorizer is CP1, and the strike-through indicates that the obligation is destroyed so the next authorizer is not applicable. The bundle includes a second obligation of CP1 to deliver 3000 USD to TP1, where the current authorizer is TP1, and the strike-through indicates that the obligation is destroyed so the next authorizer is not applicable.

Bundle 3 includes a first obligation of TP1 to deliver 2000 $XYZ shares to CP1, where the current authorizer is CP1, and the strike-through indicates that the obligation is destroyed so the next authorizer is not applicable. The bundle includes a second obligation of CP1 to deliver 12000 USD to TP1, where the current authorizer is TP1, and the strike-through indicates that the obligation is destroyed so the next authorizer is not applicable.

Bundle 4 includes a first obligation of CP1 to deliver 2000 $XYZ shares to TP1, where the current authorizer is TP1, and the strike-through indicates that the obligation is destroyed so the next authorizer is not applicable. The bundle includes a second obligation of TP1 to deliver 11000 USD to CP1, where the current authorizer is CP1, and the strike-through indicates that the obligation is destroyed so the next authorizer is not applicable.

Bundle 5 includes a first obligation of CP1 to deliver 1000 $XYZ shares to TP1, where the current authorizer is TP1, and the strike-through indicates that the obligation is destroyed so the next authorizer is not applicable. The bundle includes a second obligation of TP1 to deliver 5500 USD to CP1, where the current authorizer is CP1, and the strike-through indicates that the obligation is destroyed so the next authorizer is not applicable.

Bundle 6, which is the net bundle, includes a first obligation of TP1 to deliver 500 $XYZ shares to CP1, where the current authorizer is TP1 and the next authorizer is settlement participant SP1 on behalf of CP1. The bundle includes a second obligation of CP1 to deliver 4500 USD to TP1, where the current authorizer is CP1 and the next authorizer is SP1 on behalf of TP1.

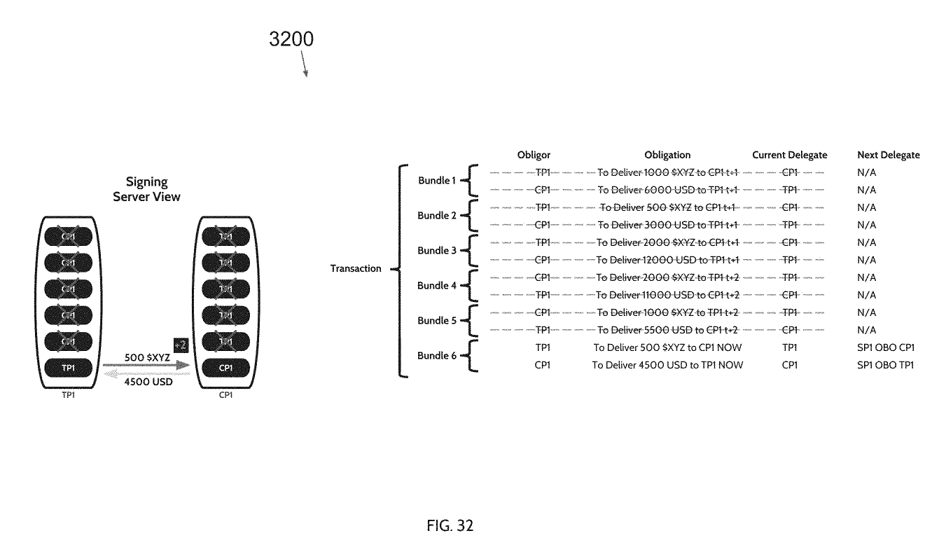

Turning to FIG. 32, an advanced net action with bilateral and same name, but across dates attributes is indicated generally by the reference numeral 3200. Here, a transaction includes six bundles, Bundle 1 through Bundle 6.

The advanced net action represents choosing a subset of obligation bundles, destroying them, and creating a new net obligation bundle to be settled. Here, a participant has selected a basket of open obligations across trade dates, and the clearing participant (CP1) has agreed to net, so the selected obligations are being submitted for settlement. Only a settlement participant (SP) can move fungible assets and effectuate a settlement, so choosing the SP as the new authorizer gives the SP control of the obligation, which it can destroy in exchange for a settlement.

Bundle 1 includes a first obligation of trading participant TP1 to deliver 1000 $XYZ shares to clearing participant CP1, where the current authorizer is CP1, and the strike-through indicates that the obligation is destroyed so the next authorizer is not applicable. The bundle includes a second obligation of CP1 to deliver 6000 USD to TP1, where the current authorizer is TP1, and the strike-through indicates that the obligation is destroyed so the next authorizer is not applicable.

Bundle 2 includes a first obligation of TP1 to deliver 500 $XYZ shares to CP1, where the current authorizer is CP1, and the strike-through indicates that the obligation is destroyed so the next authorizer is not applicable. The bundle includes a second obligation of CP1 to deliver 3000 USD to TP1, where the current authorizer is TP1, and the strike-through indicates that the obligation is destroyed so the next authorizer is not applicable.

Bundle 3 includes a first obligation of TP1 to deliver 2000 $XYZ shares to CP1, where the current authorizer is CP1, and the strike-through indicates that the obligation is destroyed so the next authorizer is not applicable. The bundle includes a second obligation of CP1 to deliver 12000 USD to TP1, where the current authorizer is TP1, and the strike-through indicates that the obligation is destroyed so the next authorizer is not applicable.

Bundle 4 includes a first obligation of CP1 to deliver 2000 $XYZ shares to TP1, where the current authorizer is TP1, and the strike-through indicates that the obligation is destroyed so the next authorizer is not applicable. The bundle includes a second obligation of TP1 to deliver 11000 USD to CP1, where the current authorizer is CP1, and the strike-through indicates that the obligation is destroyed so the next authorizer is not applicable.

Bundle 5 includes a first obligation of CP1 to deliver 1000 $XYZ shares to TP1, where the current authorizer is TP1, and the strike-through indicates that the obligation is destroyed so the next authorizer is not applicable. The bundle includes a second obligation of TP1 to deliver 5500 USD to CP1, where the current authorizer is CP1, and the strike-through indicates that the obligation is destroyed so the next authorizer is not applicable.

Bundle 6, which is the net bundle, includes a first obligation of TP1 to deliver 500 $XYZ shares to CP1 at time NOW, where the current authorizer is TP1 and the next authorizer is settlement participant SP1 on behalf of CP1. The bundle includes a second obligation of CP1 to deliver 4500 USD to TP1 at time NOW, where the current authorizer is CP1 and the next authorizer is SP1 on behalf of TP1.

In the figures that follow, locked inventory commitments and optimization is described. Three transactions are provided with the full intermediary chain created on the back of an exchange matched transaction. For ease of description, only three transactions are listed and it is assumed that they are in the same stock name, same currency, and on the same day. Also, there are six unique customers on the transactions and the participant intermediaries' customers are all going the same direction on a transaction. Here, the locked inventory is localized as the only thing that could allow a reduction in risk in the scenario presented. Furthermore, these examples represent the direct locking of inventory specifically against the obligation presented next to it.

In alternate embodiments, should there be two-directional flows for each participant as well as obligations across trade dates and asset classes, the optimization would further net obligations against offsetting obligations. For example, obligations to buy $XYZ created on date t should be available to net against obligations to sell $XYZ on date t+1 and would present the same optimization opportunity to the system as the locked inventory.

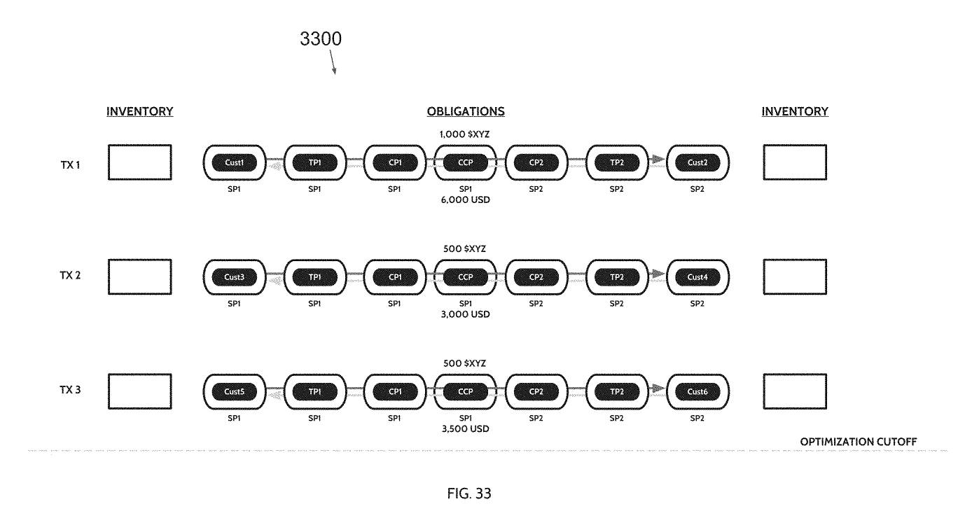

Turning now to FIG. 33, Step 1 of a batched settlement for Locked Inventory Optimization is indicated generally by the reference numeral 3300. Step 1 may assess all open obligations.

Here, each obligation pair is modelled as a transaction, with inventory tracking for each obligation side (or leg) of each transaction. A batch optimization cutoff line is indicated below the three considered transactions.

A first transaction TX1 covers a first obligation of trading participant TP1's customer Cust1 to deliver 1000 $XYZ shares to TP2's Cust2. TX1 further includes a second obligation of Cust2 to deliver 6000 USD to Cust1.

A second transaction TX2 covers a first obligation of trading participant TP1's customer Cust3 to deliver 500 $XYZ shares to TP2's Cust4. TX2 further includes a second obligation of Cust4 to deliver 3000 USD to Cust3.

A third transaction TX3 covers a first obligation of trading participant TP1's customer Cust5 to deliver 500 $XYZ shares to TP2's Cust6. TX3 further includes a second obligation of Cust6 to deliver 3500 USD to Cust5.

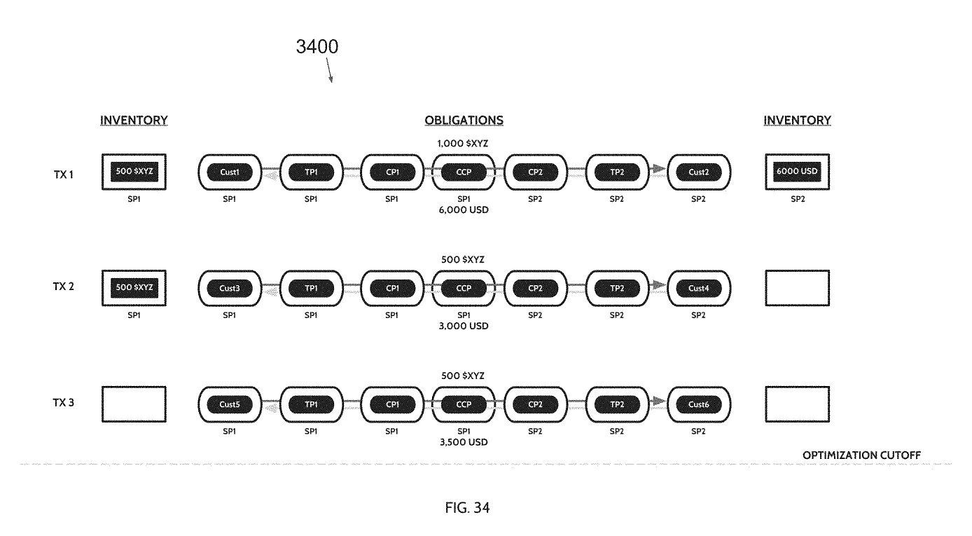

As shown in FIG. 34, Step 2 of a batched settlement for Locked Inventory Optimization is indicated generally by the reference numeral 3400. Step 2 may assess a first wave of commitments. The description for Step 1, as above, is similarly applicable here, and duplicate description may be omitted.

For Step 2, SP1receives or holds committed inventory of 500 $XYZ shares on behalf of customer Cust1 towards transaction TX1, which is only part of Cust1's 1000 $XYZ share obligation in TX1, and 500 $XYZ shares on behalf of customer Cust3 for transaction TX2. SP2receives or holds committed inventory of 6000 USD on behalf of customer Cust2 for transaction TX1.

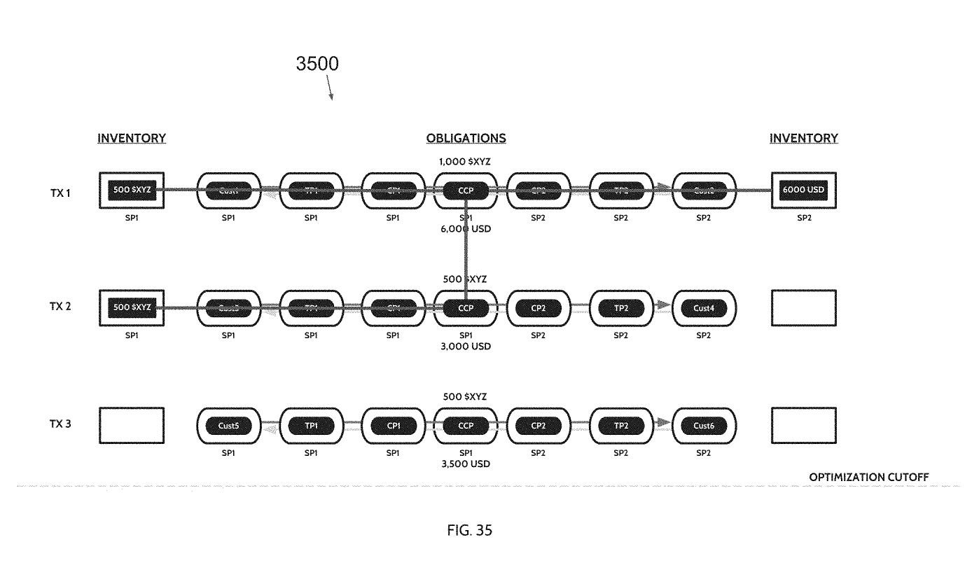

Turning to FIG. 35, Step 3 of a batched settlement for Locked Inventory Optimization is indicated generally by the reference numeral 3500. Step 3 may assess a first optimization. The description for Steps 1 and 2, as above, is similarly applicable here, and duplicate description may be omitted.

Here, the 500 $XYZ shares committed by Cust1 are combined with the 500 $XYZ shares committed by Cust3 to fulfill the 1000 $XYZ shares due to Cust2, who has committed full payment of 6000 USD. Thus, the obligations with respect to Cust2 and Cust3 may be fully settled, and the obligation with respect to Cust1 may be partially settled.

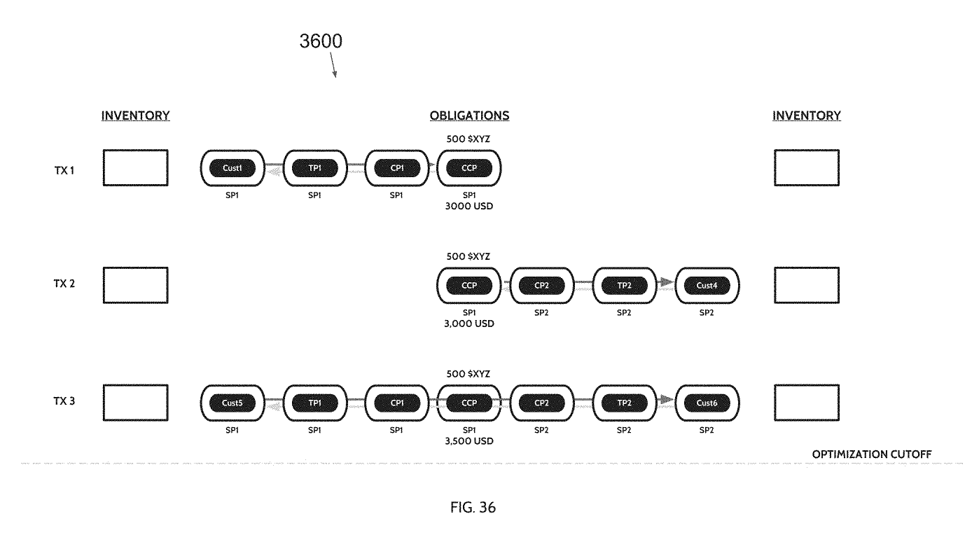

Turning now to FIG. 36, Step 4 of a batched settlement for Locked Inventory Optimization is indicated generally by the reference numeral 3600. Step 4 may assess all open obligations. The description for Steps 1, 2, and 3, as above, is similarly applicable here, and duplicate description may be omitted.

Here, the obligations that remain open include Cust1 to deliver 500 $XYZ shares and receive 3000 USD per TX1, Cust4 to deliver 3000 USD and receive 500 $XYZ shares per TX2, and all original obligations of Cust5 and Cust6 per TX3.

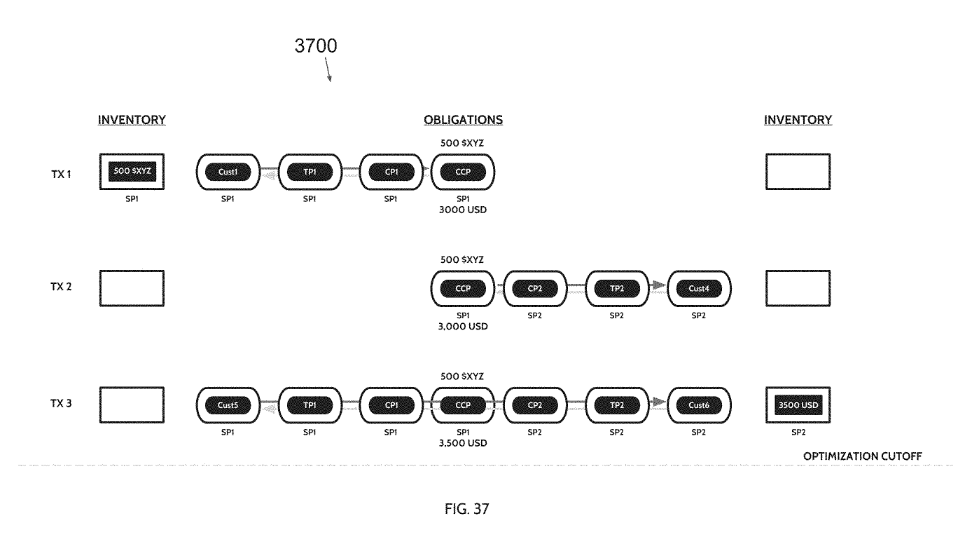

As shown in FIG. 37, Step 5 of a batched settlement for Locked Inventory Optimization is indicated generally by the reference numeral 3700. Step 5 may assess a second wave of commitments. The description for Steps 1 through 4, as above, is similarly applicable here, and duplicate description may be omitted.

Here, SP1 (receives?) holds committed inventory of 500 $XYZ additional shares on behalf of customer Cust1 towards transaction TX1, which is the remaining part of Cust1's 1000 $XYZ share obligation in TX1. SP2 (receives?) holds committed inventory of 3500 USD on behalf of customer Cust6 for transaction TX3, which is the entire obligation of Cust6 per TX3.

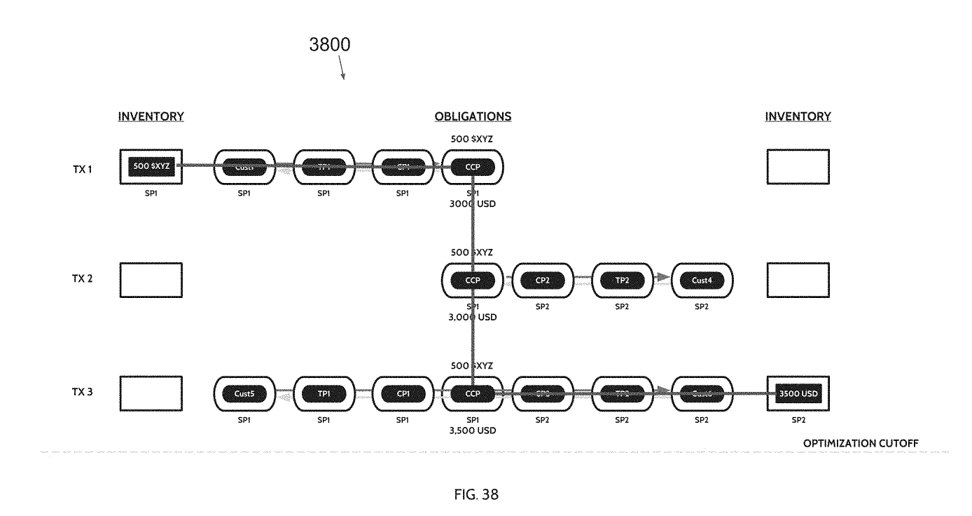

Turning to FIG. 38, Step 6 of a batched settlement for Locked Inventory Optimization is indicated generally by the reference numeral 3800. Step 6 may assess a second optimization. The description for Steps 1 through 5, as above, is similarly applicable here, and duplicate description may be omitted.

Here, the 500 $XYZ shares most recently committed by Cust1 for TX1 are partially matched with the 3500 USD committed by Cust6 for TX3, such that the obligations with each may be settled. That is, Cust6 receives 500 $XYZ shares and Cust1 receives the final 3000 USD. The remaining 500 USD is retained by SP1 for optimizing the remaining obligations of Cust4 and Cust5.

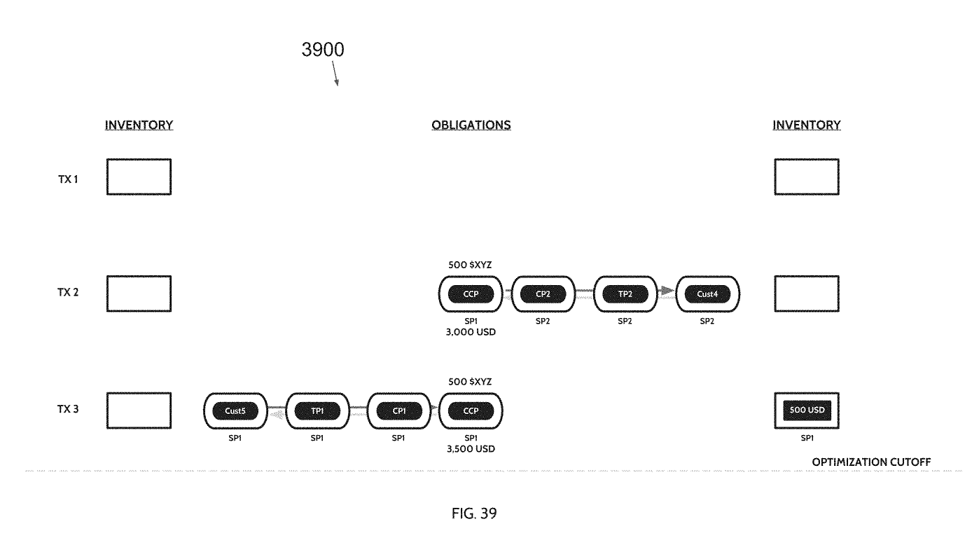

Turning now to FIG. 39, Step 7 of a batched settlement for Locked Inventory Optimization is indicated generally by the reference numeral 3900. Step 7 may assess both open obligations (as in Step 4) and leftover commitments. The description for Steps 1 through 6, as above, is similarly applicable here, and duplicate description may be omitted.

Here, the open obligations include Cust5's side of TX3 and Cust4's side of TX2. The leftover commitments include the 500 USD leftover from Cust6's side of TX3 as held by SP1. The balance of inventory resides with the CCP, who is a customer of SP1 in this example.

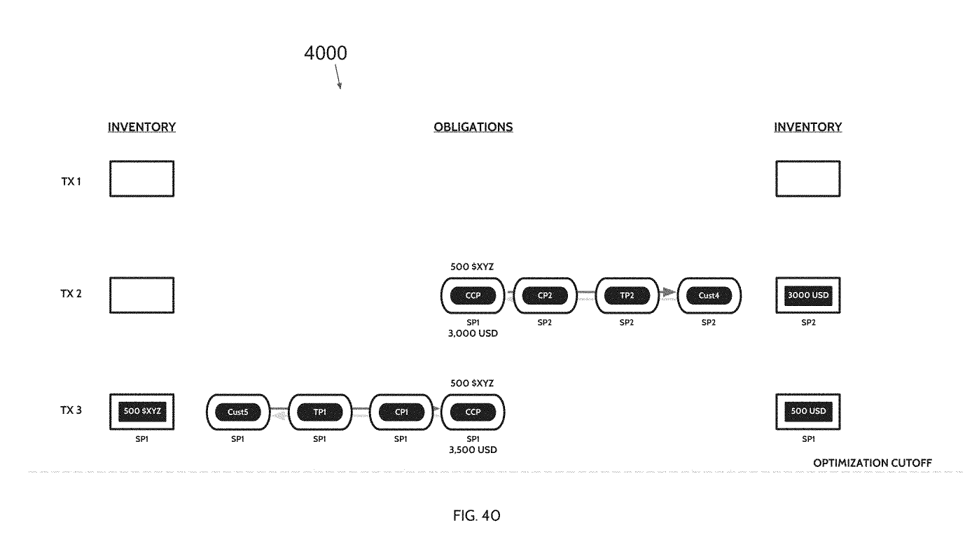

As shown in FIG. 40, Step 8 of a batched settlement for Locked Inventory Optimization is indicated generally by the reference numeral 4000. Step 8 may assess a final wave of commitments. The description for Steps 1 through 7, as above, is similarly applicable here, and duplicate description may be omitted.

Here, Cust5 commits 500 $XYZ shares held by SP1 for TX3, and Cust4 commits 3000 USD held by SP2 for TX2. SP1 still holds the leftover commitment of 500 USD from Cust6's side of TX3.

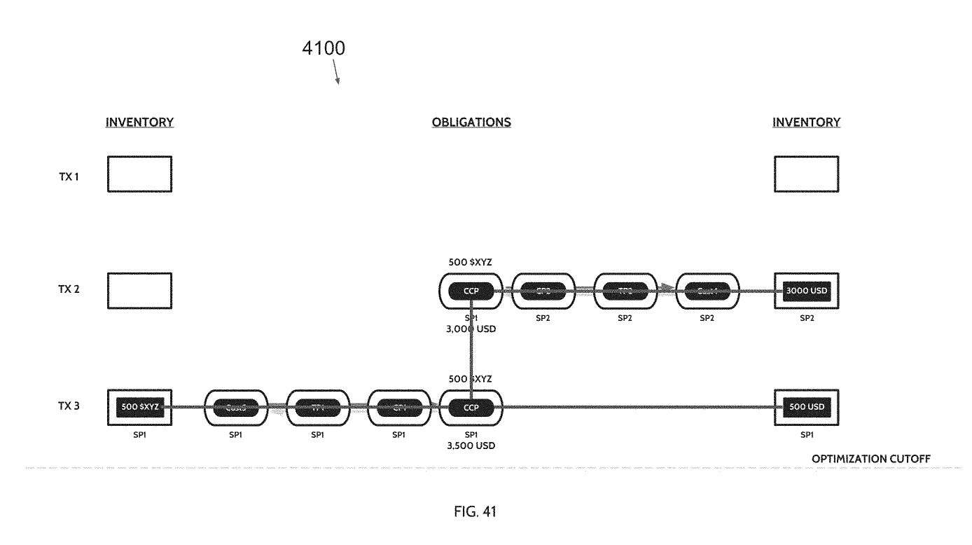

Turning to FIG. 41, Step 9 of a batched settlement for Locked Inventory Optimization is indicated generally by the reference numeral 4100. Step 9 may assess a final optimization. The description for Steps 1 through 8, as above, is similarly applicable here, and duplicate description may be omitted.

Here, the 500 $XYZ shares committed by Cust5 for TX3 are partially matched with the 3000 USD committed by Cust4 for TX2, with the 500 USD balance due to Cust5 coming from the leftover commitment held by SP1 such that the obligations with each may be settled. That is, Cust4 receives 500 $XYZ shares and Cust5 receives 3500 USD.

In the figures that follow, examples are described for generically committing inventory against all open obligations. In these examples, the inventory has been explicitly committed against the obligation created in the transaction, but the inventory has not been locked as in previous examples.

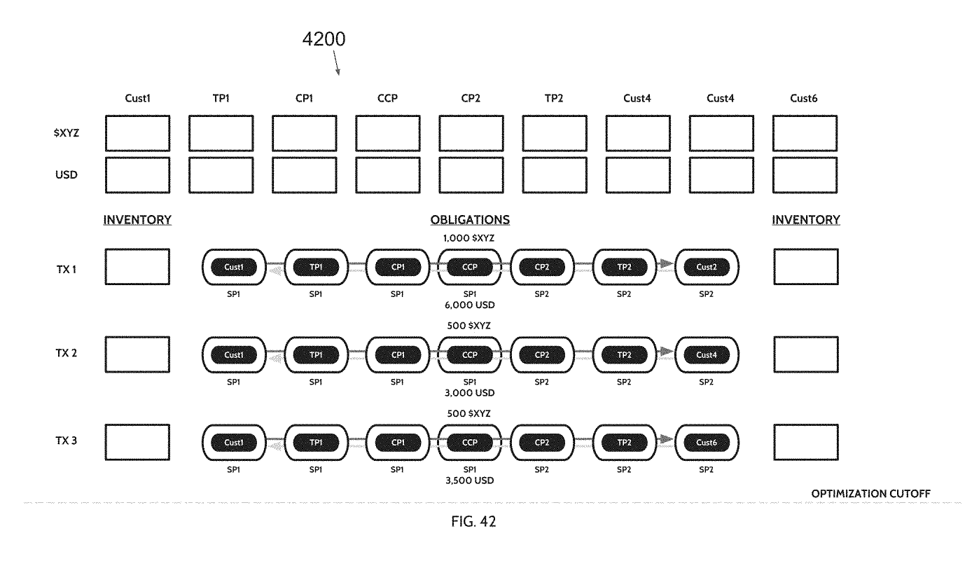

Turning now to FIG. 42, Step 1 of a batched settlement for a generic commit is indicated generally by the reference numeral 4200. Step 1 may assess all open obligations.

Here, each obligation pair is modelled as a transaction, with generic commit tracking for each leg of each obligor's obligations in the top two rows. A batch optimization cutoff line is indicated below the three considered transactions.

A first transaction TX1 covers a first obligation of trading participant TP1's customer Cust1 to deliver 1000 $XYZ shares to TP2's Cust2. TX1 further includes a second obligation of Cust2 to deliver 6000 USD to Cust1.

A second transaction TX2 covers a first obligation of trading participant TP1's customer Cust3 to deliver 500 $XYZ shares to TP2's Cust4. TX2 further includes a second obligation of Cust4 to deliver 3000 USD to Cust3.

A third transaction TX3 covers a first obligation of trading participant TP1's customer Cust5 to deliver 500 $XYZ shares to TP2's Cust6. TX3 further includes a second obligation of Cust6 to deliver 3500 USD to Cust5.

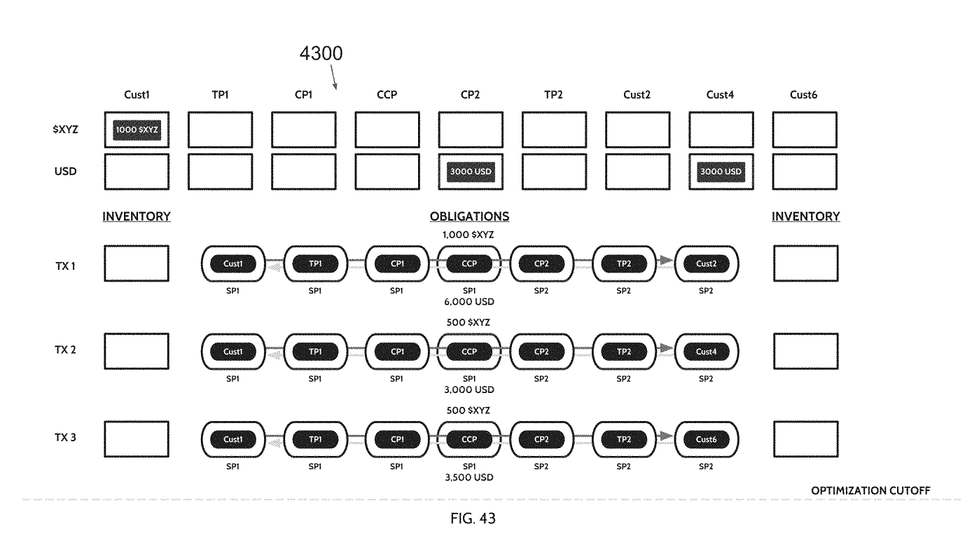

As shown in FIG. 43, Step 2 of a batched settlement for a generic commit is indicated generally by the reference numeral 4300. Step 2 may assess a first wave of commitments. The description for Step 1, as above, is similarly applicable here, and duplicate description may be omitted.

In Step 2, Cust1 has committed 1000 $XYZ shares, which is only part of Cust1's 2000 $XYZ share obligation for all three transactions. Cust4 has committed 3000 USD, which fulfills Cust4's obligation under TX2. CP2 also holds committed funds of 3000 USD.

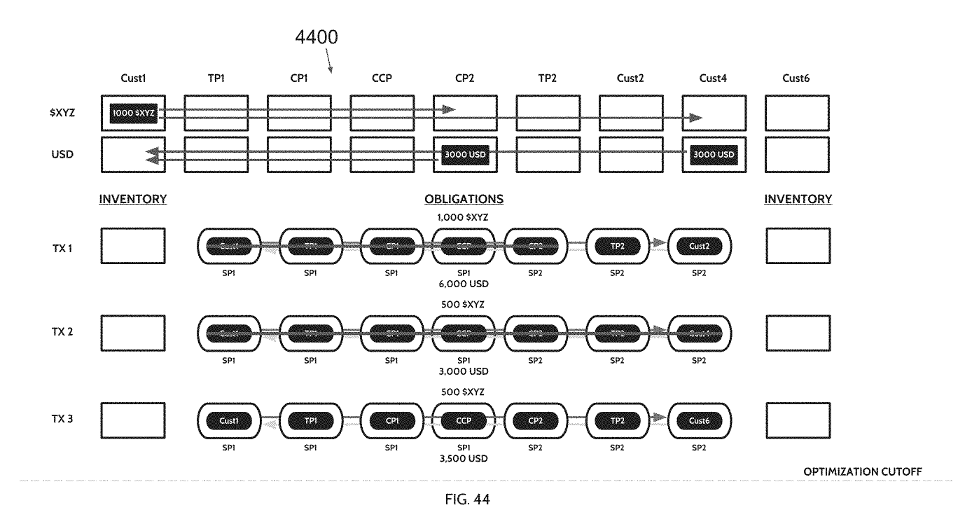

Turning to FIG. 44, Step 3 of a batched settlement for generic commit is indicated generally by the reference numeral 4400. Step 3 may assess a first optimization. The description for Steps 1 and 2, as above, is similarly applicable here, and duplicate description may be omitted.

Here, 500 of the 1000 $XYZ shares committed by Cust1 are held by CP2, and the other 500 of these shares are transferred to Cust4 to fulfill TX2. The 3000 USD committed by Cust4 is transferred to Cust1, as is the 3000 USD held by CP2.

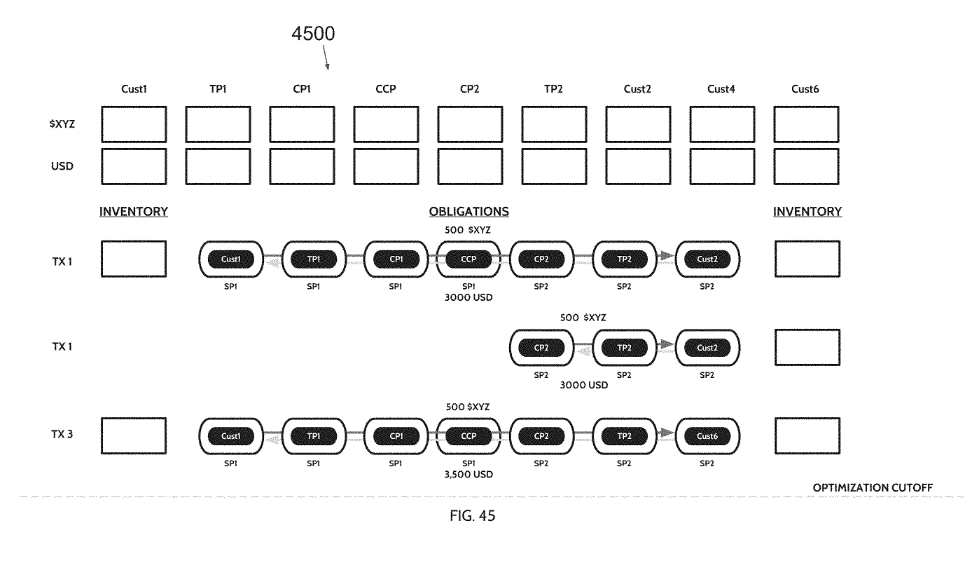

Turning now to FIG. 45, Step 4 of a batched settlement for generic commit is indicated generally by the reference numeral 4500. Step 4 may assess all open obligations. The description for Steps 1, 2, and 3, as above, is similarly applicable here, and duplicate description may be omitted.

Here, the obligations that remain open include Cust1 to deliver 500 $XYZ shares to Cust2 and receive 3000 USD from Cust2 per TX1, CP2 to deliver 500 $XYZ shares to Cust2 and receive 3000 USD from Cust2 per TX1, and Cust1 to deliver 500 $XYZ shares to Cust6 and receive 3500 USD from Cust6 per TX3.

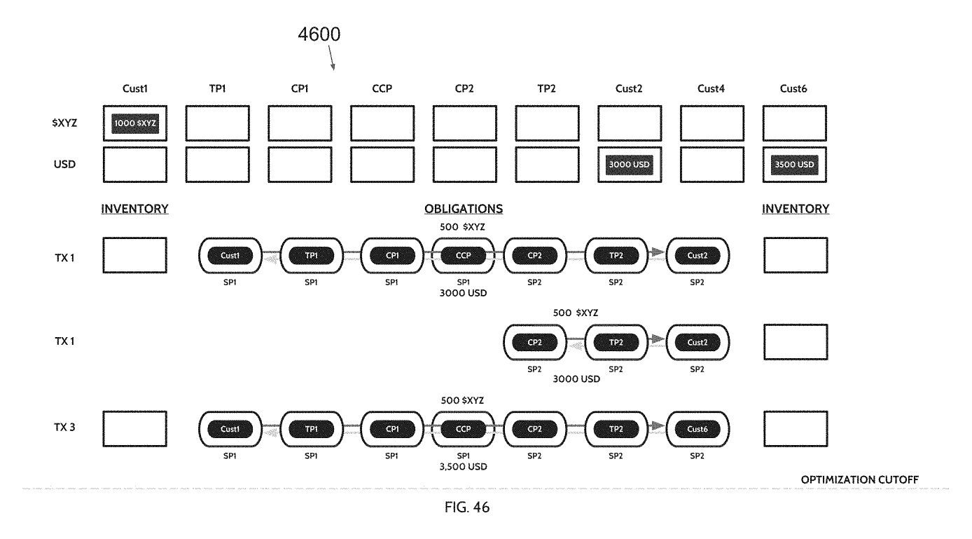

As shown in FIG. 46, Step 5 of a batched settlement for generic commit is indicated generally by the reference numeral 4600. Step 5 may assess a second wave of commitments. The description for Steps 1 through 4, as above, is similarly applicable here, and duplicate description may be omitted.

In Step 5, Cust1 has committed an additional 1000 $XYZ shares, which is the balance of Cust1's 2000 $XYZ share obligation to fulfill all three transactions (i.e., TX1, TX2, and TX3). Cust2 has committed 3000 USD, which fulfills Cust2's obligation under TX1. Cust6 has committed funds of 3500 USD, which fulfills Cust6's obligation under TX3.

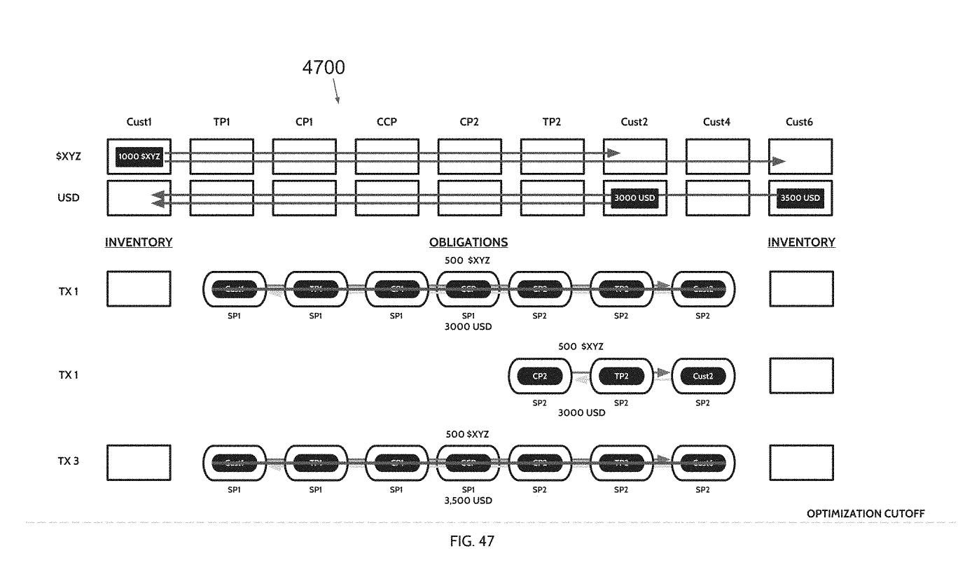

Turning to FIG. 47, Step 6 of a batched settlement for generic commit is indicated generally by the reference numeral 4700. Step 6 may assess a second optimization and settlement. The description for Steps 1 through 5, as above, is similarly applicable here, and duplicate description may be omitted.

Here, on the shares leg, 500 of the 1000 $XYZ shares are transferred from Cust1 to Cust2, and the other 500 of the 1000 $XYZ shares are transferred from Cust1 to Cust6. On the cash leg, 3500 USD is transferred from Cust6 to Cust1, and 3000 USD is transferred from Cust2 to Cust1.

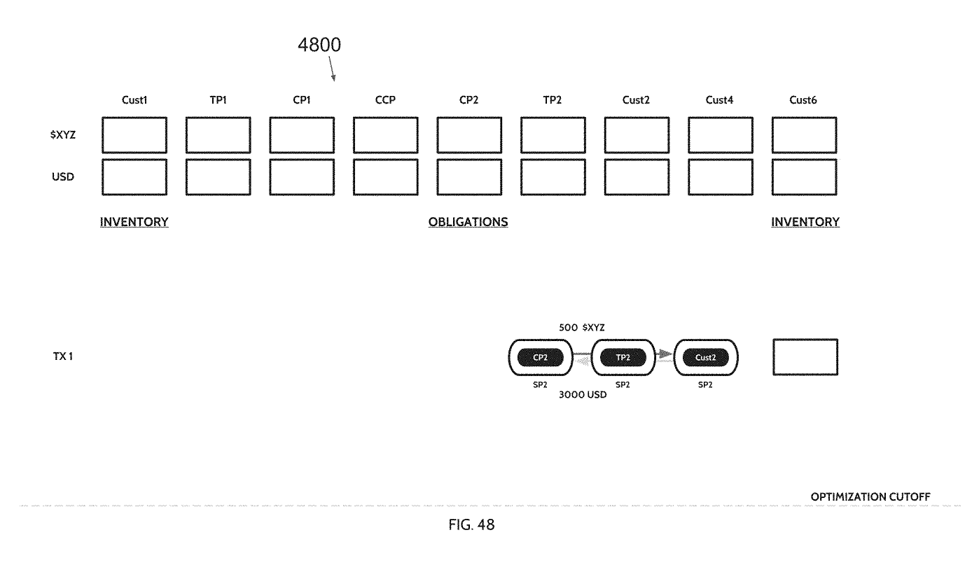

Turning now to FIG. 48, Step 7 of a batched settlement for generic commit is indicated generally by the reference numeral 4800. Step 7 may assess remaining open obligations. The description for Steps 1 through 6, as above, is similarly applicable here, and duplicate description may be omitted.

Here, the only obligations that remain open are for CP2 to deliver 500 $XYZ shares to Cust2, and for Cust2 to deliver 3000 USD to CP2. This is to fulfill TX1.

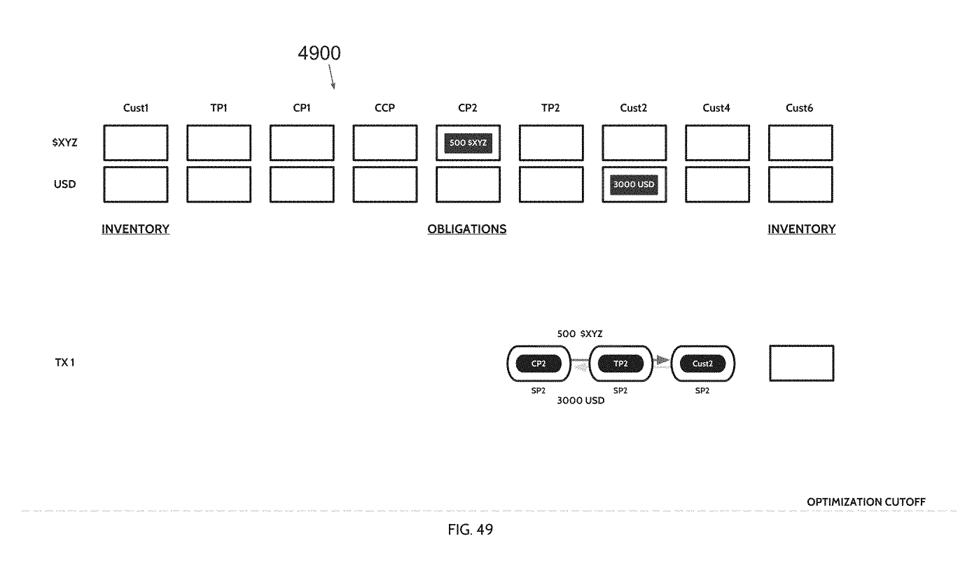

As shown in FIG. 49, Step 8 of a batched settlement for generic commit is indicated generally by the reference numeral 4900. Step 8 may assess a final commitment. The description for Steps 1 through 7, as above, is similarly applicable here, and duplicate description may be omitted.

Here, CP2 commits 500 $XYZ shares, and Cust2 commits 3000 USD. These commitments constitute the balance of assets needed to complete transaction TX1.

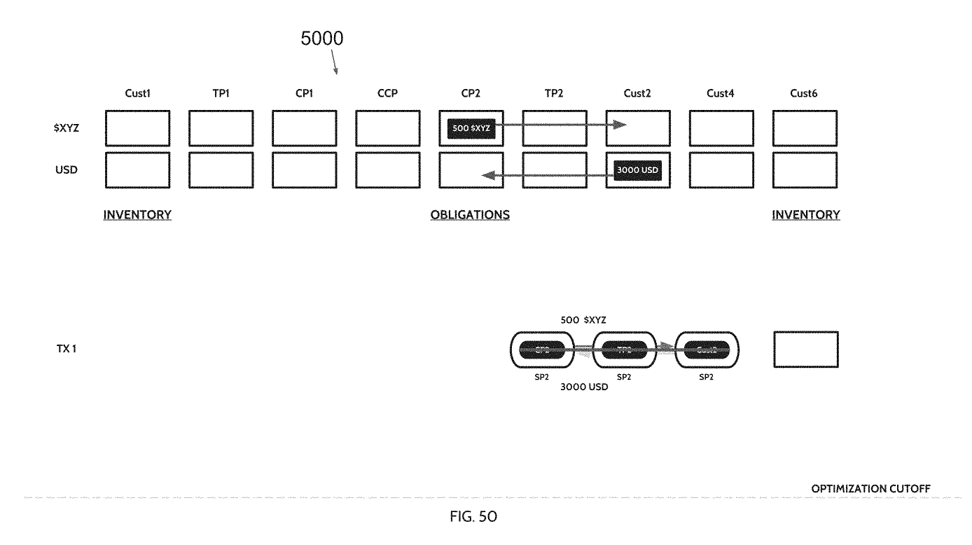

Turning to FIG. 50, Step 9 of a batched settlement for generic commit is indicated generally by the reference numeral 5000. Step 9 may assess final settlement. The description for Steps 1 through 8, as above, is similarly applicable here, and duplicate description may be omitted.

Final settlement is accomplished when CP2 transfers the committed 500 $XYZ shares to Cust2, and Cust2 transfers the committed 3000 USD to CP2. This closes out the last remaining transaction, TX1.

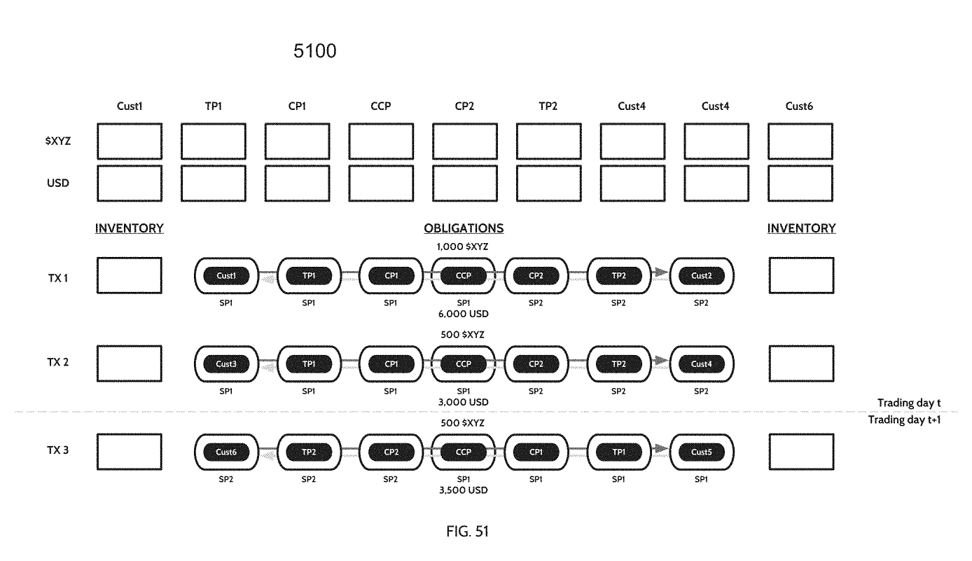

Turning now to FIG. 51, Step 1 of a cross-day netting transaction is indicated generally by the reference numeral 5100. Step 1 may assess all open obligations.

Here, each obligation pair is modelled as a transaction, with generic commit tracking for each leg of each obligor's obligations in the top two rows. A batch optimization cutoff line is indicated below the three considered transactions.

A first transaction TX1 covers a first obligation of trading participant TP1's customer Cust1 to deliver 1000 $XYZ shares to TP2's Cust2. TX1 further includes a second obligation of Cust2 to deliver 6000 USD to Cust1.

A second transaction TX2 covers a first obligation of trading participant TP1's customer Cust3 to deliver 500 $XYZ shares to TP2's Cust4. TX2 further includes a second obligation of Cust4 to deliver 3000 USD to Cust3.

A third transaction TX3 covers a first obligation of trading participant TP1's customer Cust5 to deliver 500 $XYZ shares to TP2's Cust6. TX3 further includes a second obligation of Cust6 to deliver 3500 USD to Cust5.

Batch settlements and concrete settlement times have previously prevented most markets from benefiting from the efficiencies found in cross-day netting and compression. If a participant buys a stock on date t and sells that stock on date t+1, current market practice (depending on market) is for the trades to settle on t+3 and t+4, respectively. Clearly, this is unnecessary if participants hold a ledger of all live and unsatisfied obligations at all times.

The combination of inventory commitments and cross-day netting and compression may allow for tremendous reductions in risk and capital requirements for all participants. Each obligation may continue to carry a maximum settlement time, but should be allowed to be netted across dates.

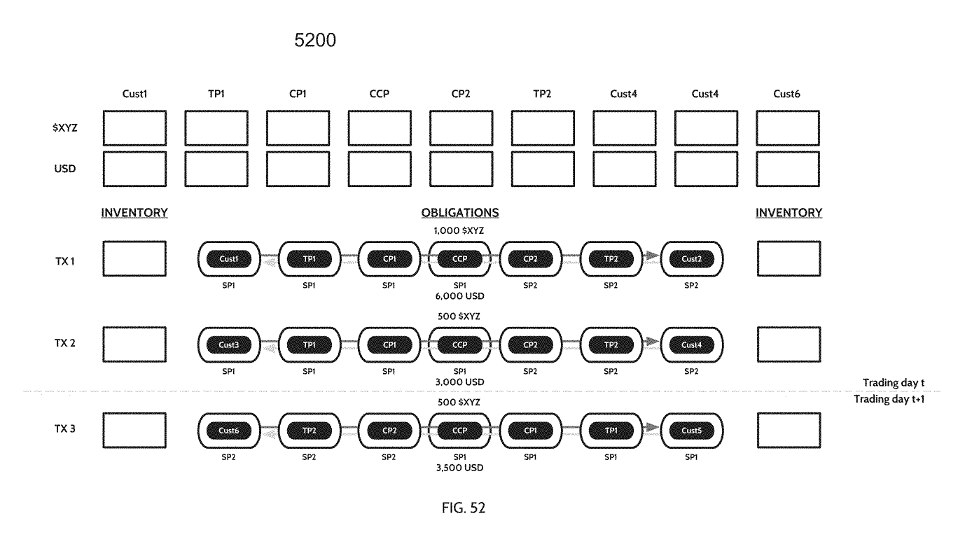

As shown in FIG. 52, Step 2 of a cross-day netting transaction is indicated generally by the reference numeral 5200. Step 2 may assess commitments. The description for Step 1, as above, is similarly applicable here, and duplicate description may be omitted. As shown, there are no commitments or inventory so far.

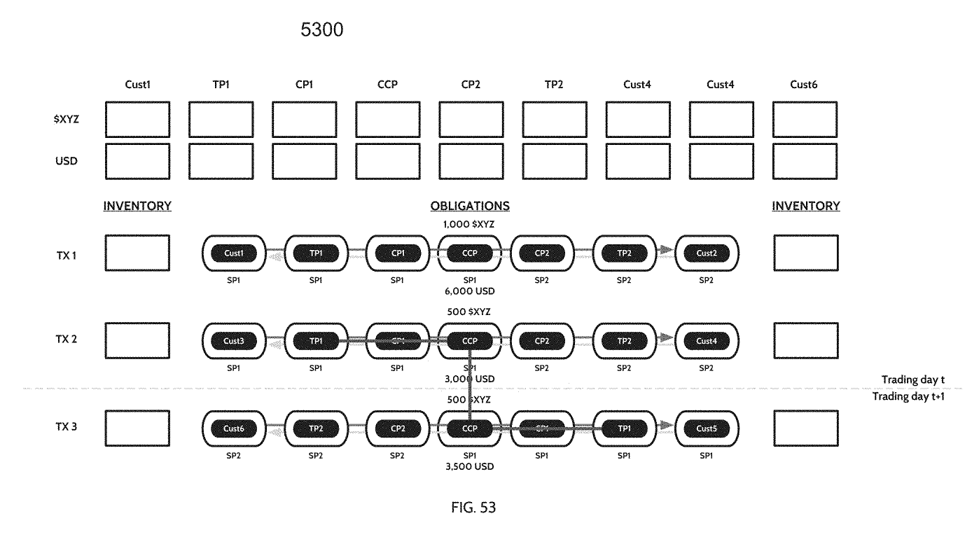

Turning to FIG. 53, Step 3 of a cross-day netting transaction is indicated generally by the reference numeral 5300. Step 3 may assess optimization and settlement. Here, CP1 nets out 500 $XYZ and 3000 USD between days t and t+1. CCP holds the extra 500 USD (3500−3000=500). The transfer obligations of TP1 with Cust3 and TP1 with Cust5 have yet to be satisfied.

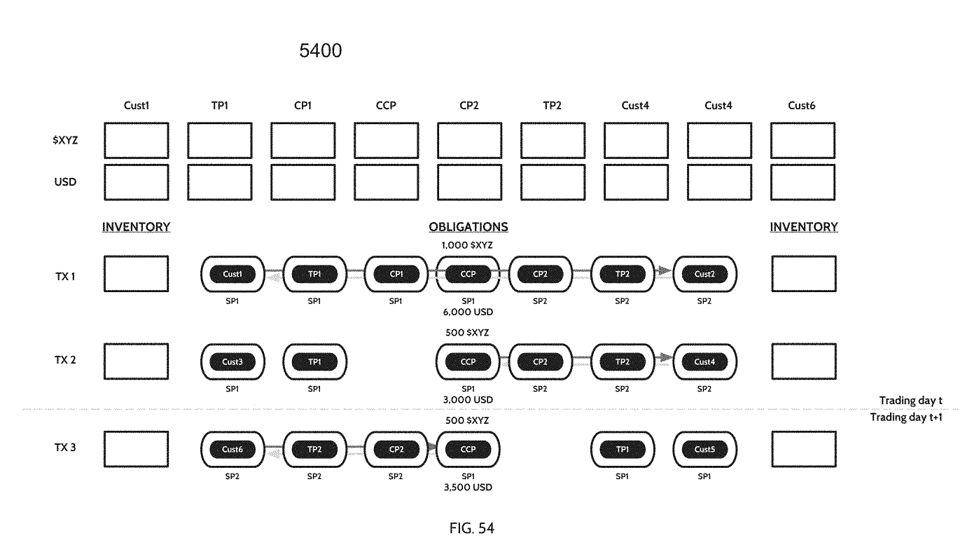

Turning now to FIG. 54, Step 4 of a cross-day netting transaction is indicated generally by the reference numeral 5400. Step 4 may assess open obligations. Here, all obligations of CP1 have been fulfilled for transactions TX2 and TX3.

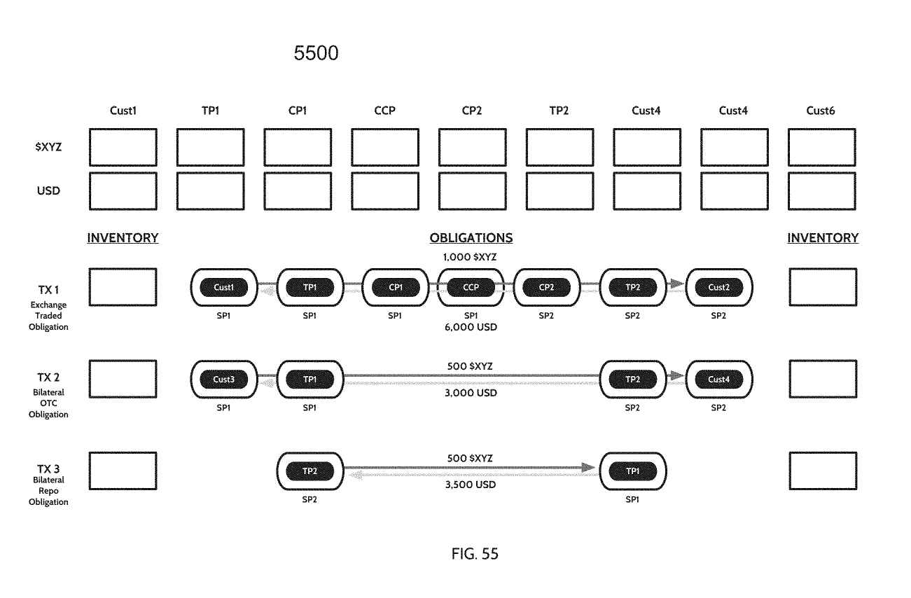

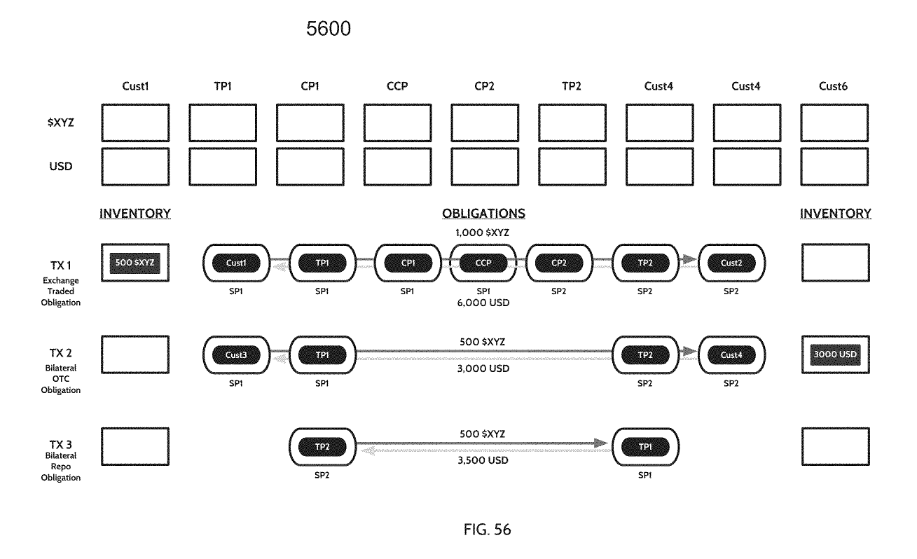

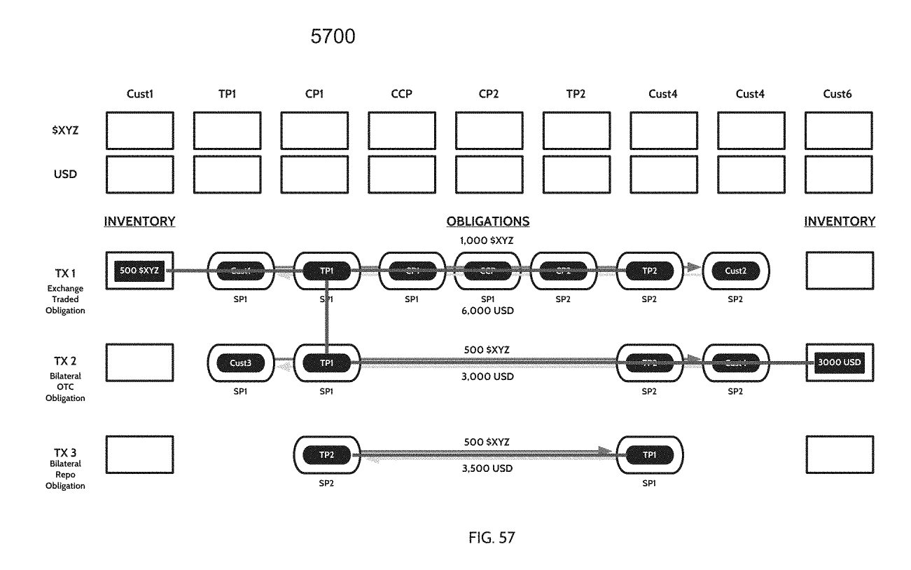

As shown in FIGS. 55-57, a unified ledger of obligations is indicated generally by the reference numerals 5500 through 5700. This is possible because, in accordance with the present inventive concept, an obligation is truly an obligation. Thus, if a market participant creates obligations via normal trading on an exchange, bilateral transactions, OTC transactions, and/or repo transactions, there is no reason that these obligations cannot be fungible against each other. This section demonstrates how a basket of obligations can be optimized against each other independent of the historic reasons for their creation.

While the inventive concept has been described by way of example with respect to non-limiting exemplary embodiments; other alternatives, modifications, and variations will be apparent to those of ordinary skill in the pertinent art. Accordingly, the scope of the appended claims is intended to include all such alternatives, modifications and variations on the exemplary embodiments set forth herein, as well as equivalents thereof that may fall within the scope and spirit of the present disclosure.

What is claimed is:

1. A method of managing a transaction having at least one enduring obligation and at least one repo obligation with respect to a plurality of assets, the method comprising:
authorizing the at least one enduring obligation and the at least one repo obligation through a mutual append-only transactional log.

2. The method of claim 1 wherein the at least one enduring obligation and the at least one repo obligation form an obligation bundle.

3. The method of claim 1, further comprising communicating statuses of the obligations among a plurality of participants.

4. The method of claim 3 wherein the plurality of participants includes a central counterparty clearinghouse associated with a first signing server.

5. The method of claim 1 wherein the plurality of assets comprises two assets selected from the group consisting of cash, securities and equities.

6. The method of claim 1 wherein the plurality of assets includes at least one of a digital asset or a tokenized non-digital asset.

7. The method of claim 1 wherein the mutual append-only transactional log is a blockchain ledger.

8. The method of claim 1, further comprising:
managing a second transaction having at least one bundle of obligations with respect to at least one of the same plurality of assets.

9. The method of claim 4, further comprising:
the signing server servicing at least one designated cryptographic account that has authorized said signing server as its respective authorizer.

10. The method of claim 9 wherein said designated cryptographic account corresponds to at least one of a Holder Identification Number (HIN) or a Security Reference Number (SRN).

11. The method of claim 1 wherein each obligation is part of a bundle comprising a plurality of obligations, the plurality including a first obligation to transfer a first digital asset from a first designated cryptographic account of a first beneficial owner to a second designated cryptographic account of a second beneficial owner, and a corresponding second obligation to transfer a second asset from a first account of the second beneficial owner to a second account of the first beneficial owner.

12. The method of claim 1, further comprising:
issuing a digital asset by creating control of the asset through a market administrator participant for an issuer's open account controlled by a settlement participant on behalf of the issuer.

13. The method of claim 11, further comprising:
matching the first obligation of the first account with the second obligation of the second account to form a bundle;
allocating at least one matched bundle comprising said bundle and concerning a same type of digital asset;
readying the allocated at least one bundle for settlement;
transferring the first digital asset from an open sub-account to a committed sub-account on behalf of the first account;
transferring the second digital asset from an open sub-account to a committed sub-account on behalf of the second account;
settling the readied bundle of obligations;
transferring the first digital asset of the settlement to an open sub-account on behalf of the second account; and
transferring the second digital asset of the settlement to an open sub-account on behalf of the first account.

14. The method of claim 11, further comprising:
matching the first obligation of the first account with the second obligation of the second account to form a bundle;
readying the bundle for settlement;
transferring the first digital asset from an open sub-account to a committed sub-account on behalf of the first account;
transferring the second digital asset from an open sub-account to a committed sub-account on behalf of the second account;
settling the readied bundle of obligations;
transferring the first digital asset of the settlement to an open sub-account on behalf of the second account; and
transferring the second digital asset of the settlement to an open sub-account on behalf of the first account.

15. The method of claim 11, further comprising:
readying for settlement a bundle of obligations including at least the first obligation and the second obligation;
transferring the first digital asset from an open sub-account to a committed sub-account on behalf of the first account;
transferring the second digital asset from an open sub-account to a committed sub-account on behalf of the second account;
settling the readied bundle of obligations;
transferring the first digital asset of the settlement to an open sub-account on behalf of the second account; and
transferring the second digital asset of the settlement to an open sub-account on behalf of the first account.

16. The method of claim 11, further comprising:
matching the first obligation of the first account with the second obligation of the second account to form a bundle;
allocating at least one matched bundle comprising said bundle and concerning a same type of digital asset;
transferring the first digital asset from an open sub-account to a committed sub-account on behalf of the first account;
transferring the second digital asset from an open sub-account to a committed sub-account on behalf of the second account;
settling the allocated bundle of obligations;
transferring the first digital asset of the settlement to an open sub-account on behalf of the second account; and
transferring the second digital asset of the settlement to an open sub-account on behalf of the first account.

17. The method of claim 16, further comprising re-allocating the at least one matched bundle comprising said bundle and concerning a same type of digital asset in the event of a de-allocation.

18. The method of claim 15, further comprising:
for a type of asset, clearer, customer, open risk, opposing endpoint, or trade size, performing at least one of matching the first obligation of the first account with the second obligation of the second account to form a bundle, or performing allocating at least one matched bundle comprising said bundle and concerning a same type of digital asset.

19. The method of claim 11, further comprising executing an exchange traded match action with respect to said bundle.

20. The method of claim 11, further comprising executing an allocation action with respect to said bundle.

21. The method of claim 11, further comprising executing a multi-allocation action with respect to said bundle.

22. The method of claim 11, further comprising executing a ready-for-settle action with respect to said bundle.

23. The method of claim 11, further comprising executing a commit action with respect to said bundle.

24. The method of claim 11, further comprising executing a settle action with respect to said bundle.

25. The method of claim 1, further comprising executing a repo transaction including at least one Bundle On obligations leg.

26. The method of claim 25, further comprising executing at least one Bundle Off obligations leg.

27. The method of claim 25 wherein the repo transaction further comprises a plurality of corresponding transfers.

28. The method of claim 1, further comprising:
if the transaction is flagged as ready to settle, reducing overall obligations by obviating the intermediate obligations of at least one clearing participant or central counter-party.

29. The method of claim 1, further comprising:
if a preference fee of type different than that of a transferring asset is offered by a party, adding a corresponding obligation of the offering party to the plurality of obligations.

30. The method of claim 1, further comprising:
if a party expresses a preference for early settlement, and an existing counterparty or intermediary does not accept early settlement, permitting a separate participant to step in and offer settlement liquidity.

31. The method of claim 30 wherein the preference includes a fee on the immediate settlement.

32. The method of claim 30 wherein the preference includes a fee on the final settlement.

33. The method of claim 1, further comprising:
netting a plurality of obligation bundles between a plurality of obligors to reduce outstanding obligations of the transaction.

34. The method of claim 33 wherein the plurality of obligation bundles is greater than the plurality of obligors.

35. The method of claim 33 wherein the plurality of obligors is two for a bilateral netting action, with the obligation bundles having the same pair of assets and the same date attributes.

36. The method of claim 33, further comprising:
if the transaction is ready to settle, delegating a resulting bundle of the netted transaction for settlement.

37. The method of claim 33 wherein at least one of the obligation bundles has a different date attribute than another of the obligation bundles for across date netting.

38. The method of claim 1, further comprising:
if there is any locked inventory on each side of a transaction, batching settlement using the locked inventory while optimizing for greatest reduction of obligations or risk.

39. The method of claim 1 wherein at least some of the obligations correspond to enduring asset transactions and at least some of the obligations correspond to repo transactions.

40. The method of claim 1, further comprising:
matching the at least one enduring obligation of a first party with the at least one repo obligation of a second party by receiving a Business Intent Message (BIM) based on the respective obligations of the parties;
selecting a transaction processing algorithm based on the BIM;
selecting relationship nodes for transaction processing based on the BIM; and
providing a Business Intent Transaction (BIT) based on the selected algorithm and nodes.

41. An asset management system comprising:
at least one signing server configured to manage a transaction having at least one enduring obligation and at least one repo obligation with respect to a plurality of assets,
wherein the at least one signing server is configured to authenticate said obligations through an append-only log.

42. The system of claim 41 wherein the at least one enduring obligation and the at least one repo obligation form an obligation bundle.

43. The system of claim 41 wherein the at least one signing server is disposed for communicating statuses of the obligations among a plurality of participants.

44. The system of claim 41 wherein transfers of the plurality of assets are controlled by a plurality of participants, including a central counterparty clearinghouse associated with a first signing server.

45. The system of claim 41 wherein the plurality of assets comprises two assets selected from the group consisting of cash, securities and equities.

46. The system of claim 41 wherein the plurality of assets includes at least one of a digital asset or a tokenized non-digital asset.

47. The system of claim 41 wherein the mutual append-only transactional log is a blockchain ledger.

48. The system of claim 41 wherein:
at least one of the obligations corresponds to an enduring securities transaction,
at least one of the signing servers is configured to manage a second transaction having at least one bundle of obligations with respect to at least one of the same plurality of digital assets,
wherein at least one of the obligations of the second transaction corresponds to an ephemeral repo transaction.

49. The system of claim 41 wherein at least one of the signing servers is configured to service at least one designated cryptographic account that has authorized said signing server as its respective authorizer.

50. The system of claim 49 wherein said designated cryptographic account corresponds to at least one of a Holder Identification Number (HIN) or a Security Reference Number (SRN).

51. The system of claim 41 wherein each obligation is part of a bundle comprising a plurality of obligations, the plurality including a first obligation to transfer a first digital asset from a first designated cryptographic account of a first beneficial owner to a second designated cryptographic account of a second beneficial owner, and a corresponding second obligation to transfer a second asset from a first account of the second beneficial owner to a second account of the first beneficial owner.

52. The system of claim 41 wherein a market administrator participant is configured to issue a digital asset by creating control of the asset for an issuer's open account controlled by a settlement participant on behalf of the issuer.

53. The system of claim 51, further comprising:
a comparator for matching the first obligation of the first account with the second obligation of the second account to form a bundle;
a memory for allocating at least one matched bundle comprising said bundle and concerning a same type of digital asset;
a flag for readying the allocated at least one bundle for settlement;
a cryptographic decoder for transferring the first digital asset from an open sub-account to a committed sub-account on behalf of the first account, and transferring the second digital asset from an open sub-account to a committed sub-account on behalf of the second account;
a signing server for settling the readied bundle of obligations; and
a cryptographic encoder for transferring the first digital asset of the settlement to an open sub-account on behalf of the second account, and transferring the second digital asset of the settlement to an open sub-account on behalf of the first account.

54. The system of claim 51, further comprising:
a comparator for matching the first obligation of the first account with the second obligation of the second account to form a bundle;
a flag for readying the bundle for settlement;
a cryptographic decoder for transferring the first digital asset from an open sub-account to a committed sub-account on behalf of the first account, and transferring the second digital asset from an open sub-account to a committed sub-account on behalf of the second account;
a signing server for settling the readied bundle of obligations; and
a cryptographic encoder for transferring the first digital asset of the settlement to an open sub-account on behalf of the second account, and transferring the second digital asset of the settlement to an open sub-account on behalf of the first account.

55. The system of claim 51, further comprising:
a flag for readying for settlement a bundle of obligations including at least the first obligation and the second obligation;
a cryptographic decoder for transferring the first digital asset from an open sub-account to a committed sub-account on behalf of the first account, and transferring the second digital asset from an open sub-account to a committed sub-account on behalf of the second account;
a signing server for settling the readied bundle of obligations;
a cryptographic encoder for transferring the first digital asset of the settlement to an open sub-account on behalf of the second account, and transferring the second digital asset of the settlement to an open sub-account on behalf of the first account.

56. The system of claim 51, further comprising:
a comparator for matching the first obligation of the first account with the second obligation of the second account to form a bundle;
a memory for allocating at least one matched bundle comprising said bundle and concerning a same type of digital asset;
a cryptographic decoder for transferring the first digital asset from an open sub-account to a committed sub-account on behalf of the first account, and transferring the second digital asset from an open sub-account to a committed sub-account on behalf of the second account;
a signing server for settling the allocated bundle of obligations;
a cryptographic encoder for transferring the first digital asset of the settlement to an open sub-account on behalf of the second account, and transferring the second digital asset of the settlement to an open sub-account on behalf of the first account.

57. The system of claim 56 wherein the memory is further configured for re-allocating the at least one matched bundle comprising said bundle and concerning a same type of digital asset in the event of a de-allocation.

58. The system of claim 55 wherein for a type of asset, clearer, customer, open risk, opposing endpoint, or trade size, the comparator is configured for performing at least one of matching the first obligation of the first account with the second obligation of the second account to form a bundle, or allocating at least one matched bundle comprising said bundle and concerning a same type of digital asset.

59. The system of claim 51 wherein the signing server is configured for executing an exchange traded match action with respect to said bundle.

60. The system of claim 51 wherein the signing server is configured for executing an allocation action with respect to said bundle.

61. The system of claim 51 wherein the signing server is configured for executing a multi-allocation action with respect to said bundle.

62. The system of claim 51 wherein the signing server is configured for executing a ready-for-settle action with respect to said bundle.

63. The system of claim 51 wherein the signing server is configured for executing a commit action with respect to said bundle.

64. The system of claim 51 wherein the signing server is configured for executing a settle action with respect to said bundle.

65. The system of claim 51 wherein the signing server is configured for executing a repo transaction including at least one Bundle On obligations leg.

66. The system of claim 65 wherein the signing server is configured for executing at least one Bundle Off obligations leg.

67. The system of claim 65 wherein the repo transaction further comprises a plurality of corresponding transfers.

68. The system of claim 41 wherein at least one of the signing servers is configured for reducing overall obligations by obviating the intermediate obligations of at least one clearing participant or central counterparty clearinghouse if the transaction is flagged as ready to settle.

69. The system of claim 41 wherein, if a preference fee of type different than that of a transferring asset is offered by a party, the system is configured for adding a corresponding obligation of the offering party to the plurality of obligations.

70. The system of claim 41 wherein, if a party expresses a preference for early settlement and an existing counterparty or intermediary does not accept early settlement, the system is configured for permitting a separate participant to step in and offer settlement liquidity.

71. The method of claim 70 wherein the preference includes a fee on the immediate settlement.

72. The system of claim 70 wherein the preference includes a fee on the final settlement.

73. The system of claim 41 wherein pre-settlement includes netting a plurality of obligation bundles between a plurality of obligors to reduce outstanding obligations of the transaction.

74. The system of claim 73 wherein the plurality of obligation bundles is greater than the plurality of obligors.

75. The system of claim 73 wherein the plurality of obligors is two for a bilateral netting action, with the obligation bundles having the same pair of assets and the same date attributes.

76. The system of claim 73 wherein, if the transaction is ready to settle, the system is configured for delegating a resulting bundle of the netted transaction for settlement.

77. The system of claim 73 wherein at least one of the obligation bundles has a different date attribute than another of the obligation bundles for across date netting.

78. The system of claim 41 wherein, if there is any locked inventory on each side of a transaction, the system is configured for batching settlement using the locked inventory while optimizing for a reduction of number of obligations or risk.

79. The system of claim 41 wherein at least some of the obligations correspond to enduring asset transactions and at least some of the obligations correspond to repo transactions.

80. The system of claim 1, further comprising:
business means for matching the at least one enduring obligation of a first party with the at least one repo obligation of a second party by receiving a Business Intent Message (BIM) based on the respective obligations of the parties;
core means for selecting a transaction processing algorithm based on the BIM;
first strategy means for selecting relationship nodes for transaction processing based on the BIM; and
second strategy means for providing a Business Intent Transaction (BIT) based on the selected algorithm and nodes.

81. A program storage device tangibly embodying a program of instructions executable by a computer to perform steps for managing a transaction having at least one enduring obligation and at least one repo obligation with respect to a plurality of assets, the steps comprising:
authorizing the at least one enduring obligation and the at least one repo obligation through a mutual append-only transactional log.

82. The device of claim 81 wherein the at least one enduring obligation and the at least one repo obligation form an obligation bundle.

83. The device of claim 81, the steps further comprising communicating statuses of the obligations among a plurality of participants.

84. The device of claim 83 wherein the plurality of participants includes a central counterparty clearinghouse associated with a first signing server.

85. The device of claim 81 wherein the plurality of assets comprises two assets selected from the group consisting of cash, securities and equities.

86. The device of claim 81 wherein the plurality of assets includes at least one of a digital asset or a tokenized non-digital asset.

87. The device of claim 81 wherein the mutual append-only transactional log is a blockchain ledger.

88. The device of claim 81, the steps further comprising:
managing a second transaction having at least one bundle of obligations with respect to at least one of the same plurality of assets.

89. The device of claim 84, the steps further comprising:
the signing server servicing at least one designated cryptographic account that has authorized said signing server as its respective authorizer.

90. The device of claim 89 wherein said designated cryptographic account corresponds to at least one of a Holder Identification Number (HIN) or a Security Reference Number (SRN).

91. The device of claim 81 wherein each obligation is part of a bundle comprising a plurality of obligations, the plurality including a first obligation to transfer a first digital asset from a first designated cryptographic account of a first beneficial owner to a second designated cryptographic account of a second beneficial owner, and a corresponding second obligation to transfer a second asset from a first account of the second beneficial owner to a second account of the first beneficial owner.

92. The device of claim 81, the steps further comprising:
issuing a digital asset by creating control of the asset through a market administrator participant for an issuer's open account controlled by a settlement participant on behalf of the issuer.

93. The device of claim 91, the steps further comprising:
matching the first obligation of the first account with the second obligation of the second account to form a bundle;
allocating at least one matched bundle comprising said bundle and concerning a same type of digital asset;
readying the allocated at least one bundle for settlement;
transferring the first digital asset from an open sub-account to a committed sub-account on behalf of the first account;
transferring the second digital asset from an open sub-account to a committed sub-account on behalf of the second account;
settling the readied bundle of obligations;
transferring the first digital asset of the settlement to an open sub-account on behalf of the second account; and
transferring the second digital asset of the settlement to an open sub-account on behalf of the first account.

94. The device of claim 91, the steps further comprising:
matching the first obligation of the first account with the second obligation of the second account to form a bundle;
readying the bundle for settlement;
transferring the first digital asset from an open sub-account to a committed sub-account on behalf of the first account;
transferring the second digital asset from an open sub-account to a committed sub-account on behalf of the second account;
settling the readied bundle of obligations;
transferring the first digital asset of the settlement to an open sub-account on behalf of the second account; and
transferring the second digital asset of the settlement to an open sub-account on behalf of the first account.

95. The device of claim 91, the steps further comprising:
readying for settlement a bundle of obligations including at least the first obligation and the second obligation;
transferring the first digital asset from an open sub-account to a committed sub-account on behalf of the first account;
transferring the second digital asset from an open sub-account to a committed sub-account on behalf of the second account;
settling the readied bundle of obligations;
transferring the first digital asset of the settlement to an open sub-account on behalf of the second account; and
transferring the second digital asset of the settlement to an open sub-account on behalf of the first account.

96. The device of claim 91, the steps further comprising:
matching the first obligation of the first account with the second obligation of the second account to form a bundle;
allocating at least one matched bundle comprising said bundle and concerning a same type of digital asset;
transferring the first digital asset from an open sub-account to a committed sub-account on behalf of the first account;
transferring the second digital asset from an open sub-account to a committed sub-account on behalf of the second account;
settling the allocated bundle of obligations;
transferring the first digital asset of the settlement to an open sub-account on behalf of the second account; and
transferring the second digital asset of the settlement to an open sub-account on behalf of the first account.

97. The device of claim 96, the steps further comprising re-allocating the at least one matched bundle comprising said bundle and concerning a same type of digital asset in the event of a de-allocation.

98. The device of claim 95, the steps further comprising:
for a type of asset, clearer, customer, open risk, opposing endpoint, or trade size, performing at least one of matching the first obligation of the first account with the second obligation of the second account to form a bundle, or performing allocating at least one matched bundle comprising said bundle and concerning a same type of digital asset.

99. The device of claim 91, the steps further comprising executing an exchange traded match action with respect to said bundle.

100. The device of claim 91, the steps further comprising executing an allocation action with respect to said bundle.

101. The device of claim 91, the steps further comprising executing a multi-allocation action with respect to said bundle.

102. The device of claim 91, the steps further comprising executing a ready-for-settle action with respect to said bundle.

103. The device of claim 91, the steps further comprising executing a commit action with respect to said bundle.

104. The device of claim 91, the steps further comprising executing a settle action with respect to said bundle.

105. The device of claim 81, the steps further comprising executing a repo transaction including at least one Bundle On obligations leg.

106. The device of claim 105, the steps further comprising executing at least one Bundle Off obligations leg.

107. The device of claim 105 wherein the repo transaction further comprises a plurality of corresponding transfers.

108. The device of claim 81, the steps further comprising:
if the transaction is flagged as ready to settle, reducing overall obligations by obviating the intermediate obligations of at least one clearing participant or central counter-party.

109. The device of claim 81, the steps further comprising:
if a preference fee of type different than that of a transferring asset is offered by a party, adding a corresponding obligation of the offering party to the plurality of obligations.

110. The device of claim 81, the steps further comprising:
if a party expresses a preference for early settlement, and an existing counterparty or intermediary does not accept early settlement, permitting a separate participant to step in and offer settlement liquidity.

111. The device of claim 110 wherein the preference includes a fee on the immediate settlement.

112. The device of claim 110 wherein the preference includes a fee on the final settlement.

113. The device of claim 81, the steps further comprising:
netting a plurality of obligation bundles between a plurality of obligors to reduce outstanding obligations of the transaction.

114. The device of claim 113 wherein the plurality of obligation bundles is greater than the plurality of obligors.

115. The device of claim 113 wherein the plurality of obligors is two for a bilateral netting action, with the obligation bundles having the same pair of assets and the same date attributes.

116. The device of claim 113, further comprising:
if the transaction is ready to settle, delegating a resulting bundle of the netted transaction for settlement.

117. The device of claim 113 wherein at least one of the obligation bundles has a different date attribute than another of the obligation bundles for across date netting.

118. The device of claim 81, the steps further comprising:
if there is any locked inventory on each side of a transaction, batching settlement using the locked inventory while optimizing for greatest reduction of obligations or risk.

119. The device of claim 81 wherein at least some of the obligations correspond to enduring asset transactions and at least some of the obligations correspond to repo transactions.

120. The device of claim 81, the steps further comprising:
matching the at least one enduring obligation of a first party with the at least one repo obligation of a second party by receiving a Business Intent Message (BIM) based on the respective obligations of the parties;
selecting a transaction processing algorithm based on the BIM;
selecting relationship nodes for transaction processing based on the BIM; and
providing a Business Intent Transaction (BIT) based on the selected algorithm and nodes.
